(19) United States
(12) Patent Application Publication
(10) Pub. No.: US 2007/0268526 A1
(43) Pub. Date: Nov. 22, 2007

(54) Network facsimile apparatus and network facsimile system

(75) Inventors: Shuichi Ito, Tokyo (JP); Toru Ichiki, Sagamihara-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/714,898

(22) Filed: Mar. 7, 2007

(30) Foreign Application Priority Data
May 22, 2006 (JP) JP2006-142155
May 22, 2006 (JP) JP2006-142156
Jun. 1, 2006 (JP) JP2006-153058

(51) Int. Cl. H04N 1/00

(52) U.S. Cl. 358/403

(57) ABSTRACT

A network facsimile apparatus for providing session control based on a session control protocol, comprising:
a storage section for storing information for identifying the own network facsimile apparatus, and identifying information for identifying a network facsimile apparatus other than the own apparatus; and a registration section for registering proxy destination information in a SIP server arranged on a network, the proxy destination information links the identifying information of the apparatus other than the own apparatus stored in the storage section with the identifying information of own apparatus.

The present application is based on Japanese Patent Application No. 2006-142155 filed in Japan on May 22, 2006, Japanese Patent Application No. 2006-142156 filed in Japan on May 22, 2006, and Japanese Patent Application No. 2006-153058 filed in Japan on Jun. 1, 2006, the entire contents of which are incorporated herein by reference.

### BACKGROUND OF THE INVENTION

The present invention relates to a network facsimile apparatus capable of facsimile communication along the communication route established by session control based on a session control protocol.

One of the methods for communication of the network facsimile is found in the art of transmitting image data by peer-to-peer connection between a transmitter and receiver through such a network as the Internet, using a Session Initiation Protocol (SIP).

In such a SIP, the identification information for identifying a facsimile apparatus at the destination of transmission (SIP address, e.g., address information based on the telephone number of the FAX by public line and the user name of the destination) and an IP (Internet Protocol) address are linked with each other, and are registered in a server (made up of a proxy server, registration server, location server and redirection server) called a SIP server arranged on the network. When the SIP server is requested for connection from the transmitter using the SIP address at a destination, the SIP server searches for the IP address corresponding to the SIP address received from the transmitter, and establishes a call connection between the transmitter and receiver of the destination, using this IP address.

Further, the SIP provides a redirection function of changing the setting in such a way that the IP address registered in the form linked with the SIP address is temporarily set to a proxy address. If there is a request from the transmitter for connection with the SIP address wherein a proxy address is set, the SIP server reports that the proxy address is set temporarily at present, and ensures that the proxy address is notified to the transmitter as a redirection response.

In some cases, the destination showing the proxy address notified in response to such a redirection response (redirection destination) may be a destination which is not intended by the sender. To avoid this, the following network-compatible facsimile apparatus has been proposed: When a redirection response has been notified, communication is automatically suspended, thereby cutting off the facsimile transmission to the destination not intended by the transmission (e.g., Patent Document 1). Further, in this apparatus, the permitted address for permitting as a proxy address on the transmitter side is registered in advance. Only when there is an agreement with the permitted address and the proxy address notified by redirection response, the message is automatically transferred to the destination indicated by this proxy address.

### [Patent Document 1] Japanese Patent Laid-Open Publication No. 2005-94662

In the aforementioned technology, upon receipt of a redirection response, the message is not sent to the proxy address other than the preset permitted address. This arrangement does not permit transmission to a destination not intended by the sender. However, there is one proxy address that can be registered in the SIP server in the form linked with each FAX number. Accordingly, the only possibility of selection that can be made on the part of the transmitter having received the redirection response is the step of determining whether or not the message should be sent to the proxy address. Thus, even if there are multiple terminals that can be used as a proxy device of a certain FAX number on the network, the user on the transmitter side is not allowed to select the transfer destination from among a plurality of proxy devices, according to this conventional art.

As described above, transmission to the proxy address other than the permitted address is suspended, and therefore, the redirection function prepared in the SIP is not sufficiently utilized in this conventional art.

Further, to use the redirection function, it is important that the proxy address can be easily registered in the SIP server and the work related to the cancellation of registration can be simply performed.

For example, when a failure has occurred to the receiver, and receiving has been disabled, or there is no person close to the receiver during the nighttime, it would be convenient if the message can be transferred to another receiver using a redirection function. However, when it is necessary for an operator to input every proxy address manually or to register the proxy address in the SIP server and to cancel the registration, such arrangement is inconvenient. Not only that, when a failure has occurred, transfer to the redirection destination cannot be set to the SIP server since the operator is not present nearby.

In the case of a facsimile apparatus having a telephone function combining a telephone function with a facsimile function, the proxy address for telephone and the proxy address for facsimile may be separately set. In this case, if the transmitter side cannot be determined whether each proxy address returned as a redirection response is a proxy address for telephone or a proxy address for facsimile, facsimile transmission may be provided erroneously to the telephone set. Further, when facsimile transmission is tried in the beginning, it will be convenient if the proxy address for facsimile is automatically selected from among a plurality of proxy addresses returned as a redirection response.

### SUMMARY

One aspect of the invention is a network facsimile apparatus for providing session control based on a session control protocol comprises: a storage section for storing identification information for identifying the own network facsimile apparatus, and identification information for identifying a network facsimile apparatus other than the own apparatus; and a registration section for registering proxy destination information in a SIP server arranged on a network, the proxy destination information associating the identification information of the apparatus other than the own apparatus with the identification information of the own apparatus each stored in the storage section.

Another aspect of the invention is a network facsimile apparatus for providing session control based on a session control protocol, comprising: a requesting section for requesting a SIP server arranged on a network to connect with a destination terminal; a receiving section for receiving, from the SIP server, identification information including supplementary information of a plurality of devices other than the destination terminal, as a response to the request for connection; and an extracting section for extracting the specific information including predetermined supplementary information, out of the specific information of the plurality of devices received by the receiving section, wherein the network facsimile apparatus provides communication control in which the destination indicated by the specific information extracted by the extracting section is used as a proxy destination of the destination terminal.

Still another aspect of the invention is a network facsimile system comprising: a network facsimile apparatus on a transmitter side for providing session control based on a session control protocol; a network facsimile apparatus on a receiver side; and a SIP server arranged on a network;

wherein the network facsimile apparatus on the receiver side sends identifying information of the own apparatus, and identifying information including the supplementary information of a plurality of other apparatuses linked with the identifying information of the own apparatus, and registers such information in the SIP server; wherein the network facsimile apparatus on the transmitter side requests the SIP server to connect with the network facsimile apparatus on the receiver side; the SIP server, when required by the network facsimile apparatus on the transmitter side to connect with the network facsimile apparatus on the receiver side, ensures that the identifying information including the supplementary information of a plurality of other apparatuses registered in the form linked with the identifying information of the network facsimile apparatus on the receiver side is transmitted to the network facsimile apparatus on the transmitter side; and the network facsimile apparatus on the transmitter side, when the identifying information including the supplementary information of the plurality of other apparatuses other than the network facsimile apparatus on the receiver side has been received from the SIP server, as a response to the request for connection, extracts the identifying information including predetermined supplementary information, out of the identifying information of the plurality of other apparatuses having been received, and provides communication control wherein the destination indicated by the extracted identifying information is used as a proxy destination of the destination terminal.

A further aspect of the invention is a network facsimile apparatus for providing session control based on a session control protocol, comprising: a registration section for registering in a SIP server arranged on a network, identifying information for identifying the own apparatus and identifying information for identifying a plurality of other network facsimile apparatuses capable of being used as a proxy for the own apparatus, wherein the identifying information for identifying the own apparatus is linked with the identifying information for identifying the other network facsimile apparatuses.

A still further aspect of the invention is a network facsimile apparatus for providing session control based on a session control protocol, comprising: a requesting section for requesting a SIP server arranged on a network to connect with a destination terminal; a receiving section for receiving, from the SIP server, identifying information of a plurality of other network facsimile apparatuses other than the destination terminal, as a response to the request for connection; and a display section for displaying the identifying information for identifying the network facsimile apparatus of the plurality of other network facsimile apparatuses received by the receiving section.

A still further aspect of the invention is a network facsimile system comprising: a network facsimile apparatus on a transmission side for providing session control based on a session control protocol; a network facsimile apparatus on a receiver side; and a SIP server arranged on a network; wherein the network facsimile apparatus on the receiver side sends identifying information for identifying the own apparatus and identifying information for identifying a network facsimile apparatus of a plurality of other apparatuses capable of being used as a proxy for the own apparatus, to the SIP server, wherein the information for identifying the own apparatus is linked with the information for identifying the network facsimile apparatus of the plurality of other apparatuses; wherein the network facsimile apparatus on the transmitter side requires the SIP server to connect with the network facsimile apparatus on the receiver side; and wherein the SIP server, when requested by the network facsimile apparatus on the transmitter side to connect with the network facsimile apparatus on the receiver side, sends to the network facsimile apparatus on the transmitter side the identifying information of the network facsimile apparatus of the plurality of other apparatuses registered in the form linked with the identifying information of the network facsimile apparatus on the receiver side.

### BRIEF DESCRIPTION OF THE DRAWINGS

FIG. 1 is an explanatory diagram representing the schematic structure of a network facsimile apparatus as an embodiment of the present invention and an example of the structure of a network facsimile system;

FIG. 2 is an explanatory diagram representing the detailed structure of the network facsimile system and exchange of responses with the Method;

FIG. 3 is an explanatory diagram representing communication procedures when there is facsimile transmission from the network facsimile apparatus on the transmitter side to the network facsimile apparatus on the receiver side;

FIG. 4 is a flowchart showing manual registration to be performed in the network facsimile apparatus;

FIG. 5 is a flowchart showing the process of starting the administrator mode to be performed in the network facsimile apparatus;

FIG. 6 is a flowchart showing the process of terminating the administrator mode to be performed in the network facsimile apparatus;

FIG. 7 is a flowchart showing the process of inputting the scope of searching by the network facsimile apparatus at the source of search;

FIG. 8 is a flowchart showing the process of search performed in the network facsimile apparatus at the source of search; and

FIG. 9 is a flowchart showing the process of SNMP reception performed in each network facsimile apparatus.

FIG. 10 is an explanatory diagram representing an example of the structure of a network facsimile system as an embodiment of the present invention;

FIG. 11 is a flowchart showing the process of redirection being set by the facsimile apparatus on the receiver side;

FIGS. 12(a), 12(b) and 12(c) are explanatory diagrams showing an example of the transition of the operation screen displayed on the operation display section of the facsimile apparatus on the receiver side when setting the redirection destination;

FIG. 13 is a flowchart showing the process by the facsimile apparatus on the transmitter side;

FIG. 14 is an explanatory diagram showing an example of the destination table listing the destination information of a plurality of redirection destinations included in the redirection response; and

FIG. 15 is an explanatory diagram representing the destination list created after the redirection destination for facsimile is extracted from the destination table of FIG. 14.

FIG. 16 is an explanatory diagram representing an example of the structure of a network facsimile system as an embodiment of the present invention;

FIG. 17 is a flowchart showing the processing when the facsimile apparatus on the receiver side sets redirection;

FIGS. 18(a), 18(b) and 18(c) are explanatory diagrams showing an example of the transition of the operation screen displayed on the operation display section of the facsimile apparatus on the receiver side when setting the redirection destination;

FIG. 19 is a flowchart showing the processing by the facsimile apparatus on transmitter side;

FIGS. 20(a) and 20(b) are explanatory diagrams showing an example of the tabulated list screen of the redirection destinations displayed on the facsimile apparatus on the receiver side;

FIG. 21 is a flowchart showing the process of marking performed by the facsimile apparatus on the receiver side;

FIG. 22 is an explanatory diagram showing an example of the tabulated list screen wherein the redirection destination to be masked is indicated by crosshatching; and

FIGS. 23(a) and 23(b) are explanatory diagrams showing an example of the tabulated list screen before and after sorting when signal reception is enabled.

### DESCRIPTION OF PREFERRED EMBODIMENTS

The following describes the embodiment of the present invention with reference to drawings:

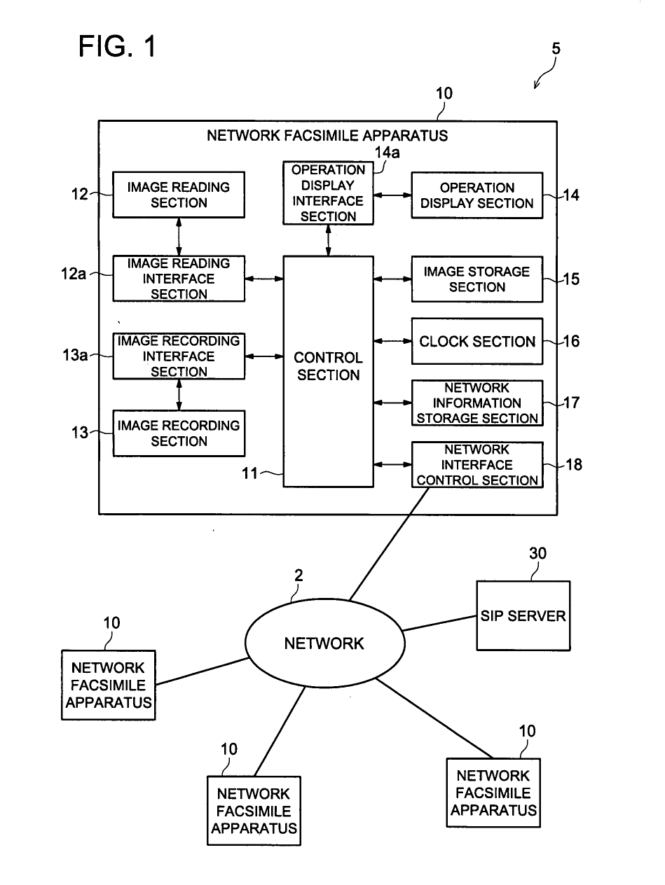

FIG. 1 shows an example of the network facsimile system 5 including the network facsimile apparatus 10 as an embodiment of the present invention. The network facsimile system 5 uses the session control protocol to execute call connection, and establishes peer-to-peer connection between the transmitter and receiver via the network 2 to transmit image information. The network facsimile system 5 is made up of a SIP server 30 and a plurality of network facsimile apparatus 10 connected to such a network 2 as the Internet.

The network facsimile apparatus 10 is a network-compatible facsimile apparatus to provide session control based on the session control protocol. It is made up of the controller 11 mainly formed of a CPU (Central Processing Unit), wherein this controller 11 is connected with:

an image reading section 12 for acquiring image data by optically reading the document,

an image recording section 13 for printing an image on a recording sheet,

an operation display section 14 for displaying the operation screen and receiving the user operation,

an image storage section 15 formed of a memory for storing image memory and a hard disk apparatus,

a clock section 16 for counting date and time,

a network information storage section 17 for storing various forms of information on the communications based on SIP, and

an network interface controller 18 having the function of exchanging various forms of data with other terminals and SIP server 30 through the network 2.

The image reading section 12 is connected to the controller 11 through an image reading interface section 12a, the image recording section 13 is connected thereto through an image recording interface section 13a, and the operation display section 14 is connected thereto through an operation display I/F section 14a.

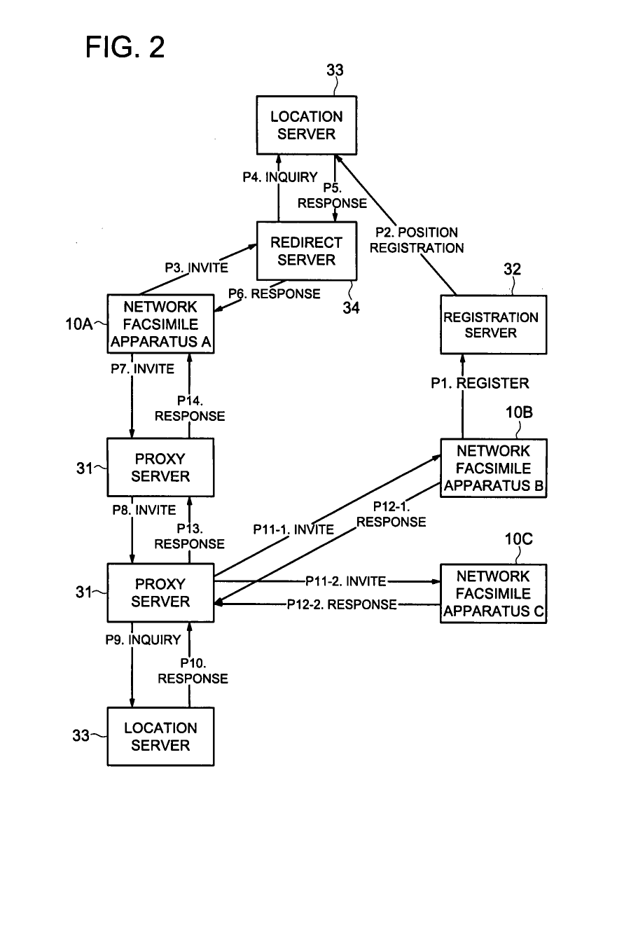

The SIP server 30 is made up of a plurality of servers such as a proxy server 31, registration server 32, location server 33 and redirection server 34, as shown in FIG. 2, for example. The functions of a plurality of these servers may be incorporated into one device. The establishment/end of the session in the SIP is executed by exchanging the Method and the response corresponding thereto.

From the network facsimile apparatus 10, the registration server 32 receives request for registration of the position information on the network 2 of that apparatus. The position information includes the SIP address of the own device (e.g., telephone number (FAX number) of the own device in the public line, the user name assigned to this apparatus, or address information based on the apparatus name), the address information of the own device on the network 2 (the IP address of the own device in this case) and other information wherein these pieces of information are linked.

The location server 33 has a database function to store and preserve the position information received by the registration server 32. It provides the relevant position information in response to the inquiry from the proxy server 31 or redirection server 34. The proxy server 31 relays the Method and response from the network facsimile apparatus 10 to the next server.

Upon receipt of the request for connection from the network facsimile apparatus 10 on the transmitter side using the SIP address of the network facsimile apparatus 10 on the receiver side, the SIP server 30 seeks the IP address linked with the SIP address thereof from the position information stored and preserved in the location server 33, and uses the IP address to execute call connection between the network facsimile apparatus 10 on the transmitter side and network facsimile apparatus 10 on receiver side.

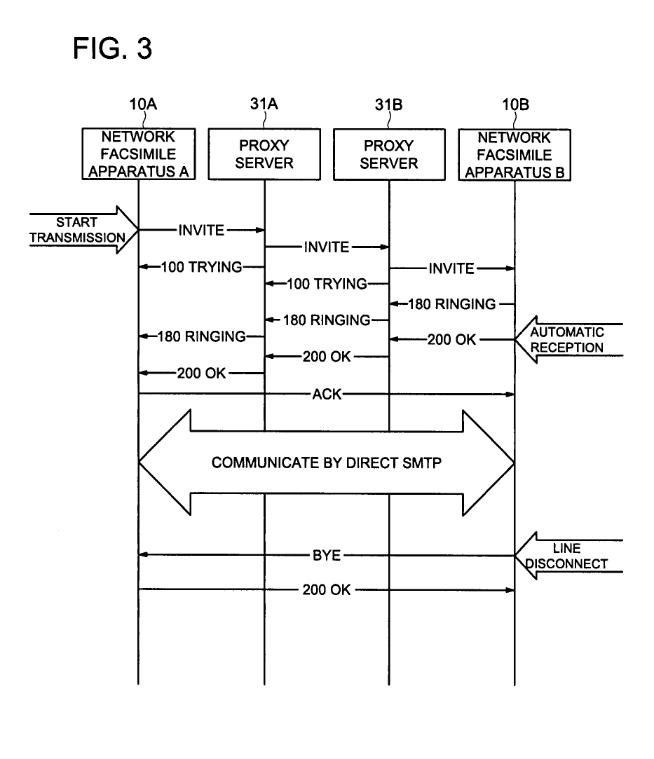

FIG. 3 shows the communications procedure when facsimile transmission is executed from the network facsimile apparatus 10 on the transmitter side A to the network facsimile apparatus 10 on receiver side B in the network facsimile system 5. The network facsimile apparatus 10 on the transmitter side A issues a Method INVITE to the network facsimile apparatus 10 on the receiver side B to prompt session to be established. The Method INVITE is relayed by the proxy servers 31A and 31B and reaches the network facsimile apparatus 10B. In this case, each of the proxy servers 31A and 31B returns a response code 100 TRYING to the source of transmission from which it has received the Method INVITE, wherein this code indicates the message that the request signal is being sent to the later stage.

Upon receipt of the Method INVITE, the network facsimile apparatus 10B sends a response code 180 RINGING to the network facsimile apparatus 10A. Further, at the time of incoming signal, the network facsimile apparatus 10B sends a response code 200 OK to the network facsimile apparatus 10A. These signals are relayed by the proxy servers 31B and 31A to reach the network facsimile apparatus 10A. Upon receipt of the response code 200 OK, the network facsimile apparatus 10A directly sends the Method ACK signal to the network facsimile apparatus 10B, whereby session is established.

After establishment of the session, facsimile communication of image data is executed according to a desired protocol. For example, a protocol conforming to the Recommendation T.37 or T.38 of the ITU-T (International Telecommunication Union-Telecommunication sector) is utilized. In this example, the direct SMTP (Simple Mail Transfer Protocol) is used for communication.

Upon completion of facsimile communication, the Method BYE is sent from the network facsimile apparatus 10 on the receiver side B to the network facsimile apparatus 10 on the transmitter side A. Then the network facsimile apparatus 10A returns the response code 2000 OK, whereby session is established.

Going back to FIG. 2, the following describes the redirection function:

The network facsimile apparatus 10 (e.g., network facsimile apparatus 10B of FIG. 2) ensures that the identifying information of another device other than the own device (IP address of another device in this case) is temporarily registered in the location server 33 and redirection server 34 of another device (FIG. 2, P1, P2) in the form linked with the SIP address of the own device (the identifying information of the own device). (This registration will be called the redirection setting). This allows the setting to be made in such a way that the facsimile transmission to the own device is transferred to the network facsimile apparatus 10C of another device (redirection destination).

The SIP server 30 receives of the request for connection given to the network facsimile apparatus 10B from the network facsimile apparatus 10 on the transmitter side A, wherein the aforementioned redirection is set (P3). Then the redirection server 34 sends an enquiry to the location server 33 (P4), and the location server 33 sends back a response to this enquiry (P5). Used as a redirection response (P6), the identifying information of the redirection destination 10C registered in the form linked with the SIP address of the network facsimile apparatus 10B (IP address of the other device) is sent to the network facsimile apparatus 10 on the transmitter side A.

The network facsimile apparatus 10A re-issues the Method INVITE to the IP address of the other device notified by the redirection response, whereby session is established with respect to the network facsimile apparatus 10C (redirection destination) handled as a proxy device of the network facsimile apparatus 10B which is the original destination (P7 through P14). This allows image data to be transmitted.

The following describes the redirection setting to be performed by the network facsimile apparatus 10 on the receiver side:

The network facsimile apparatus 10 ensures that the identifying information of the own device and the identifying information of the network facsimile apparatus of one or a plurality of other devices other than the own device are stored in the network information storage section 17 as a storage section. Then one piece of identifying information of the other device is selected from the information stored in the network information storage section 17, using an selector (not illustrated). The proxy destination information for establishing a linkage between the identifying information of the other device and the identifying information of the own device is registered in the SIP server 30 by an registration section (not illustrated), whereby redirection setting can be executed. For example, the selector function is accomplished by an operation display section 14 and controller 11. The registration section function is accomplished by a controller 11 and network interface controller 18.

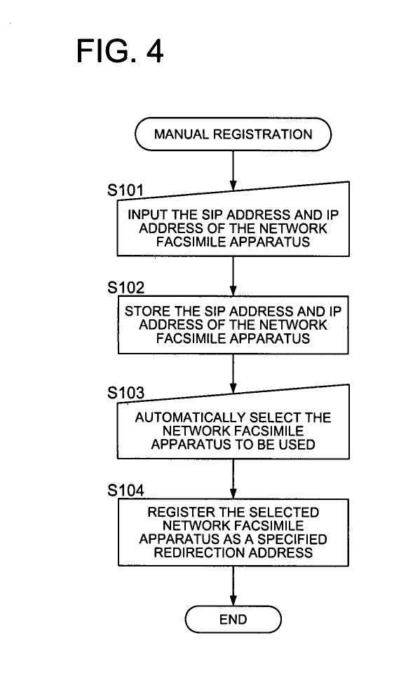

FIG. 4 shows the manual registration flow for registration the identifying information of the other device by the user operation. From the operation display section 14, the network facsimile apparatus 10 receives the input of SIP address and IP address of the own device as the identifying information of the own device, and the input of the IP address of the other device as the identifying information of the other device (Step S101). The identifying information of the own device and identifying information of the other device having been inputted are stored in the network information storage section 17 (Step S102). A plurality of the identifying information items of the other device can be stored.

Further, in response to the operation of selecting one other device (hereinafter referred to as “specified redirection destination”) employed at the time of redirection setting executed automatically according to the occurrence of a predetermined event (Step S103), out of one or a plurality of other devices stored in the network information storage section 17, information for identifying the specified redirection destination having been selected is registered in the network information storage section 17 (Step S104). The information for identifying the specified redirection destination having been selected can be provided, for example, when some identification information is added to the identifying information of the other device selected as the specified redirection destination, or the identifying information of the other device selected as the specified redirection destination is stored in a specific region.

The aforementioned predetermined event includes shift to the administrator mode or service mode, turning off of the power source of the relevant network facsimile apparatus 10, advent of the specified point of time (for registration), and occurrence of an error of disabled signal reception due to a paper jam and others at the time of specifying the point of time. The system can also receive the specified point of time for disabling (for canceling) the redirection preset according to the point of time for registration.

When a predetermined event has occurred, the network facsimile apparatus 10 automatically sets the redirection on the SIP server 30 in such a way that the specified redirection destination set in advance is a transfer destination. When an event forming a pair with the event at the time of setting (e.g., turning on of power source in contrast to turning off of power source) has occurred, the information for canceling the aforementioned setting of redirection is sent to the SIP server 30.

For example, general operations such as facsimile reception are disabled in administrator mode or service mode. Accordingly, when the operation mode of the own device has shifted to the administrator mode or service mode, redirection is set. When the system has quitted the administrator mode or service mode, redirection setting is cancelled. Thus, when the system shifts to the administrator mode or service mode, transmission to the own device is received by proxy by the other device. This arrangement eliminates the time when signal reception is disabled.

If an error of disabled transmission has occurred to paper jam or shortage of toner, for example, redirection is automatically set in such a way that the other network facsimile apparatus 10 located close to this network facsimile apparatus 10 is used as the specified redirection destination. When the error has been released and reception has been enabled, the aforementioned setting of redirection is automatically cancelled. This arrangement will be convenient.

If the function of specifying the point of time is used, it is possible to solve the problem which may occur when the location of the user changes according to the time zone of the day (e.g., during the nighttime, during the day). For example, automatic switching of the settings can be made as follows: Signals are received by the network facsimile apparatus 10 of the office during the day during the nighttime. The document sent to the network facsimile apparatus 10 of the office is transferred to the network facsimile apparatus 10 located at home. To be more specific, upon arrival of the point of time for registration such as 10:00 p.m., redirection is set so that the home-based apparatus is the specified redirection destination. Upon arrival of the specified point of time for cancellation such as 8:00 a.m., the previous setting of redirection is cancelled.

Further, the following methods can be mentioned for automatic setting of the redirection and canceling of this setting in response to the on/off operation of power source: For example, during the nighttime or on holidays, there will be a remarkable reduction in the frequency of receiving facsimile transmission. In a big office, each section is provided with a network facsimile apparatus 10. Power consumption costs will expand if all of these apparatuses are operated during the nighttime or on holidays. To solve this problem, only a specific network facsimile apparatus 10 out of multiple apparatuses is kept turned of, with all the rest turned off during the nighttime or on holidays. Redirection setting is automatically applied in such a way that the data will be transferred to this specific operating apparatus by the step of turning off the power source. When the power source has been turned on, the redirection setting is cancelled automatically. This arrangement allows the signal receiving operation to be maintained, without wasting energy.

The operation display section 14 is used to perform the operation for the shift to the administrator mode or service mode, the operation for quitting the operation mode, and the operation for setting the point of time for registration or cancellation. Whether the time for registration or cancellation has come or not is determined by the time counted by the clock section 16.

The specified redirection destination can be set according to event. For example, it is also possible to make the following arrangement: A system is so designed as to permit separate setting of the specified redirection destination automatically registered in the SIP server 30 when shifting to the administrator mode, the specified redirection destination automatically registered in the SIP server 30 when the power source is turned off, the specified redirection destination automatically registered in the SIP server 30 upon arrival of the time for registration, and the specified redirection destination automatically registered in the SIP server 30 when an error has occurred. The specified redirection destination conforming to the type of the event having occurred is registered in the SIP server 30.

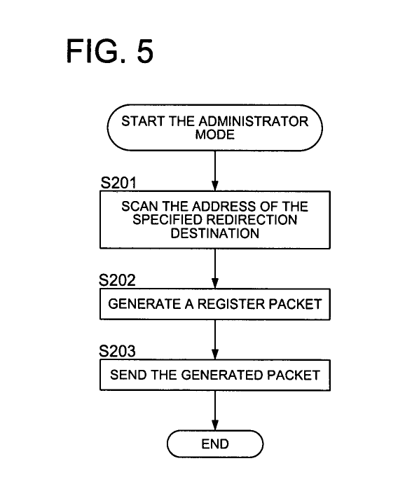

FIG. 5 shows the processing to be executed when the operation of shifting to the administrator mode has been performed. When a predetermined operation is performed by the operation display section 14, and the operation mode of the network facsimile apparatus 10 has shifted to the administrator mode, the identifying information of the own device (SIP address of the own device) stored in the network information storage section 17 and the identifying information of the specified redirection destination (IP address of the specified redirection destination) are read out (Step S201). The system creates a REGISTER packet including the proxy destination information for linking these information items (Step S202), and this packet is transmitted to the SIP server 30 (registration server 32) (Step S203). The processing is now complete.

The SIP server 30 having received this packet ensures that the proxy destination information in this packet is registered in the location server 33 and redirection server 34, and sets redirection to the SIP address contained in this proxy destination information. After that, in response to the request for connection (establishment of session) to this SIP address, the SIP server 30 ensures that the redirection response containing the identifying information of the specified redirection destination linked with this SIP address is returned to the transmission terminal at the source requesting the connection.

When the redirection setting is registered, the term of validity for registration is specified. This is specified by the Expires header of the SIP. The term of validity is so designed that switching can be performed between temporary and permanent registration according to the length of the term of validity, when registered in the location server 33.

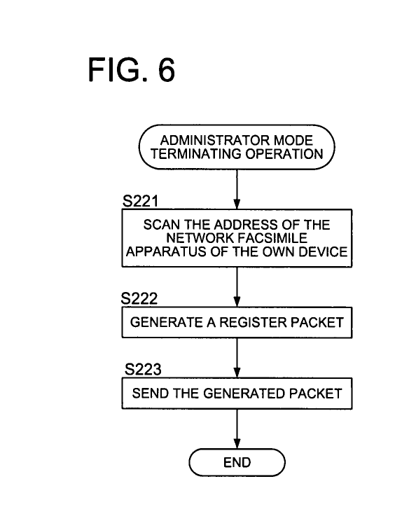

FIG. 6 shows the processing in the case of quitting the administrator mode. When operation has been made to quit the administrator mode by the operation display section 14, the network facsimile apparatus 10 reads out the identifying information of the own device (SIP address and IP address of the own device) stored in the network information storage section 17 (Step S221), and creates a REGISTER packet including the same (Step S222). This packet is sent to the SIP server 30(registration server 32) for processing of transmission (Step S223).

The SIP server 30 having received this packet ensures that the identifying information in this packet is registered in the location server 33 and redirection server 34, thereby disabling the redirection setting for the SIP address included in this identifying information. After that, upon receipt of the request for connection (establishment of session) for this SIP address, the SIP server 30 makes an attempt to establish the session with the receiving terminal of the IP address linked with this SIP address.

As described above, the operation of shifting to the administrator mode automatically provides redirection setting with respect to the SIP server 30, using the specified redirection destination stored in the network information storage section 17 in advance. Further, the operation of quitting the administrator mode automatically disables the previous redirection setting. This permits the user to automatically utilize the redirection function without having to separately perform the operation for redirection setting or releasing the setting.

An example of the administrator mode is used for explanation with reference to FIG. 5 and FIG. 6. The same applies to the specified point of time (time for registration and time for cancellation) and on/off operation of the power source. Occurrence of such events automatically leads to redirection setting and release (cancellation) of the redirection setting using the specified redirection destination stored in the network information storage section 17 in advance.

The following describes the case wherein the identifying information of the other device is automatically stored.

FIG. 4 shows an example wherein the identifying information of the other device (IP address) stored in the network information storage section 17 is inputted by the user. For example, it is possible to make such arrangements that the network facsimile apparatus 10 of the other device is automatically searched (sought) within the range of the specified IP address, and the other device having been detected is automatically stored in the network information storage section 17.

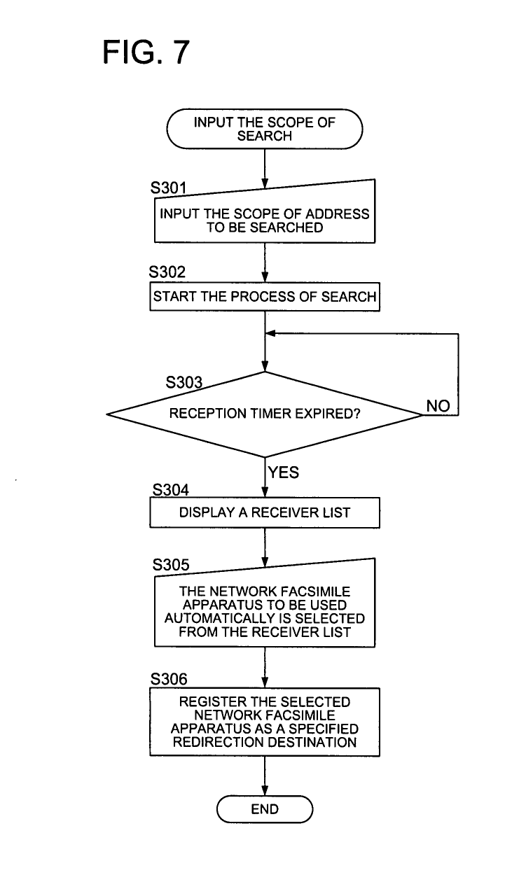

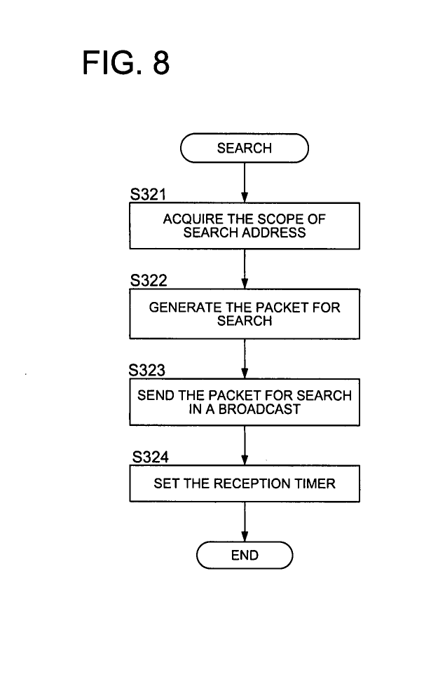

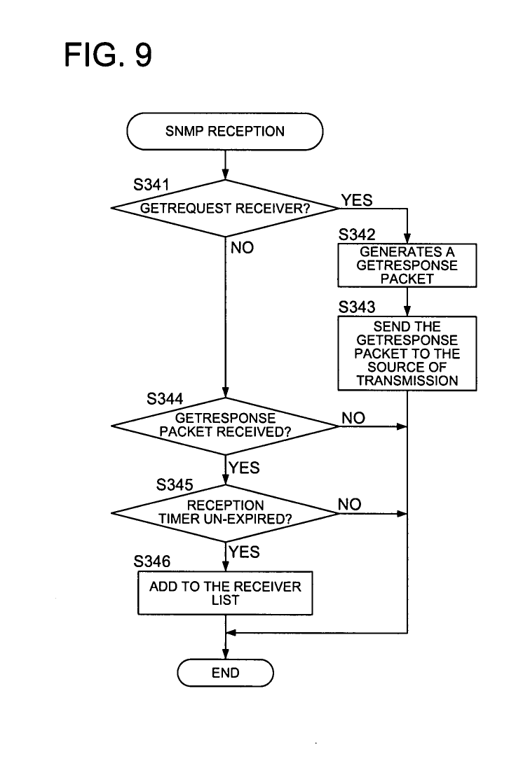

FIG. 7 shows the flow of the operation related to search and storage, FIG. 8 the flow of searching, and FIG. 9 the flow of reception of SNMP (Simple Network Management Protocol) used for searching. In the case of another device, In the first place, the search range (e.g., identifying the higher-order digit of the IP address, region, and the floor of a building) is specified (Step S301) on the search range input screen (not illustrated) displayed in the operation display section 14. When the search range has been specified, the system starts the process of searching in FIG. 8 (Step S302).

In the process of searching, for example, the specified searched address range is obtained (Step S321), and the GetRequest command packet of the search SNMP is generated (Step S322). This packet is transmitted to the broadcast address including the specified searched address range (Step S323). Then the receiving timer for time-out is set (Step 5324). The processing is now complete.

The process of SNMP reception of FIG. 9 is always carried out in each network facsimile apparatus 10. FIG. 9 shows both the processing at the terminal on the side of transmitting the GetRequest command packet and processing at the terminal on the side of receiving the packet. If there is any other device in the specified search range, the other device receives the GetRequest command packet (Y in Step S341), and generates the GetResponse command packet (Step S342). This is sent to the source that has transmitted the GetRequest command packet (Step S343).

If the network facsimile apparatus 10 having generated the GetRequest command packet for search has received the GetResponse command packet from the other device (Y in Step S344 and Y in S345) before the time set on the receiving timer expires, this identifying information of the other device is stored in the network information storage section 17 (Step S346), based on the information having been received. In this case, the received information is additionally stored in the receiving equipment list (not illustrated). The received information includes the IP address of the other device, model name, apparatus name, and apparatus installation site.

When the time set on the receiving timer has expired (Y in Step S303 of FIG. 7), a decision step is taken to determine that search has terminated. Then the contents of the receiving equipment list stored so far in the step S346 of SMP receiving are displayed on the operation display section 14 (Step S304). In response to the operation of selecting one other device to be set as the specified redirection destination (Step S305), from this receiving equipment list, the information for identifying the specified redirection destination having been selected is stored in the network information storage section 17 (Step S306). Then the processing terminates. In this processing, it is also possible to make such arrangements that the information on the identifying information of the own device is stored in the network information storage section 17. The identifying information of the own device can be stored in the network information storage section 17 in a separate processing.

As described above, a search section is provided to search the network facsimile apparatus of the other device within the search range set by the search range setting section. Then the identifying information of the network facsimile apparatus of the other device extracted by this search is stored in the network information storage section 17. This arrangement reduces the user's load on this storage, and allows the identifying information of the other device to be easily registered in the network information storage section 17. It is also possible to make such arrangements that, if no item regarding the search range has been inputted through the search range setting section, a step of search is applied to all the range that can be searched.

In the aforementioned first embodiment, the identifying information on a plurality of other devices is stored in the storage section, and one other device is selected from among a plurality of these other devices. The proxy destination information on one other device having been selected is registered in the SIP server. This selection can be made by the user or can be automatically selected by the apparatus based on various conditions and settings.

In the aforementioned first embodiment, the network facsimile apparatus of the other device is searched using the IP address within the specified search range in the in-house LAN (Local Area Network) and others. The identifying information of the other device having been found out by this search is automatically stored in the storage section. This arrangement reduces the load of the user in storing the identifying information of the other device in the storage section, and enhances the convenience of the system.

In the aforementioned the first embodiment, after the power source has been turned off, reception by the own device is disabled. When the power source has been turned off, the proxy destination information is automatically registered in the SIP server based on the information stored in the storage section before the power source is turned off. This procedure automatically ensures reception by the proxy equipment after the power source has been turned off.

In the aforementioned the first embodiment, this network facsimile apparatus is a receiver, and the identifying information for identifying the own device and the identifying information on one other receiver (redirection destination) as a proxy for the own device are stored in the storage section. When the redirection destination is registered in the SIP server, the proxy destination information that provides linkage between the identifying information of one other device stored in the storage section and the identifying information of the own device is sent to the SIP server. Use of the information stored in the storage section eliminates the need of setting the identifying information of the other device and the identifying information of the own device from the operation panel and others, every time registration is performed.

When the proxy destination information has been registered in the SIP server, and the request to the own device for connection is sent from the transmission terminal to the SIP server, the redirection response based on this proxy destination information is reported to the transmission terminal.

The identifying information of the own device can be defined as the identification information (SIP address) used by the SIP server to identify the network facsimile apparatus in the session control protocol. It is exemplified by the address information using the telephone number (FAX number) of the own device in the public line and the user name and apparatus name assigned to this apparatus. The identifying information of the other device is the information used to identify on the network the device required for the own device and other device to communicate with each other via the network. For example, the IP address of the other device and e-mail address are used. The proxy destination information is the information used to ensure linkage between the identifying information of the own device and the identifying information of the other device. It is exemplified by the information that links the SIP address of the own device with the IP address of the other device.

In the aforementioned first embodiment, when the power source of the own device is turned off, the proxy destination information registered in the SIP server is automatically disabled if the power source of the own device power source is turned on.

Further, in the aforementioned first embodiment, general operations such as facsimile reception are disabled in the administrator mode and service mode. When the operation mode of the own device has been shifted to the administrator mode or service mode, the proxy destination information is automatically registered in the SIP server based on the information stored in the storage section. This procedure ensures that, while the system is placed in the administrator mode or service mode, the transmission to the own device is received in the proxy mode by the other device. This eliminates the possibility of the reception being completely disabled.

The administrator/service mode is a generic name that indicates the operation mode wherein the facsimile reception is disabled. In this case, minor differences in the term can be ignored; for example, the term “maintenance mode” can be used to represent the same meaning.

In the aforementioned embodiment, when the mode is shifted to the administrator mode or service mode, the proxy destination information registered in the SIP server is automatically cancelled when the user quits this operation mode.

When the specified point of time has arrived, proxy destination information is automatically registered in the SIP server based on the information stored in the storage section. For example, it is possible to make such arrangements of automatic registration that data is transferred to the other device during the nighttime. A plurality of specified points of time can be set. Setting can be made according to the day of the week or month.

In the aforementioned embodiment, when the specified time has arrived, proxy destination information registered in the SIP server is disabled. For example, the reception mode can be automatically switched in such a way that data is received by the other device (e.g., home-based apparatus) during the nighttime, and by the own device during the day.

In the network facsimile apparatus of the present invention, the redirection destination as a proxy for the own device can be registered in the SIP server based on the information stored in the storage section of the own device. This procedure reduces the workload in registering the redirection destination in the SIP server, and encourages the use of the redirection function.

Particularly when automatic search of the other device is carried out within the specified IP address range, or registration of the redirection destination and cancellation of registration are automatically carried out in response to such an event as on/off operation of the power source, transfer to the administrator mode, and arrival of the specified point of time, convenience on the part of the receiver in terms of registration is further enhanced, and use of the redirection function is more utilized.

The following describes the second embodiment of the present invention with reference to drawings.

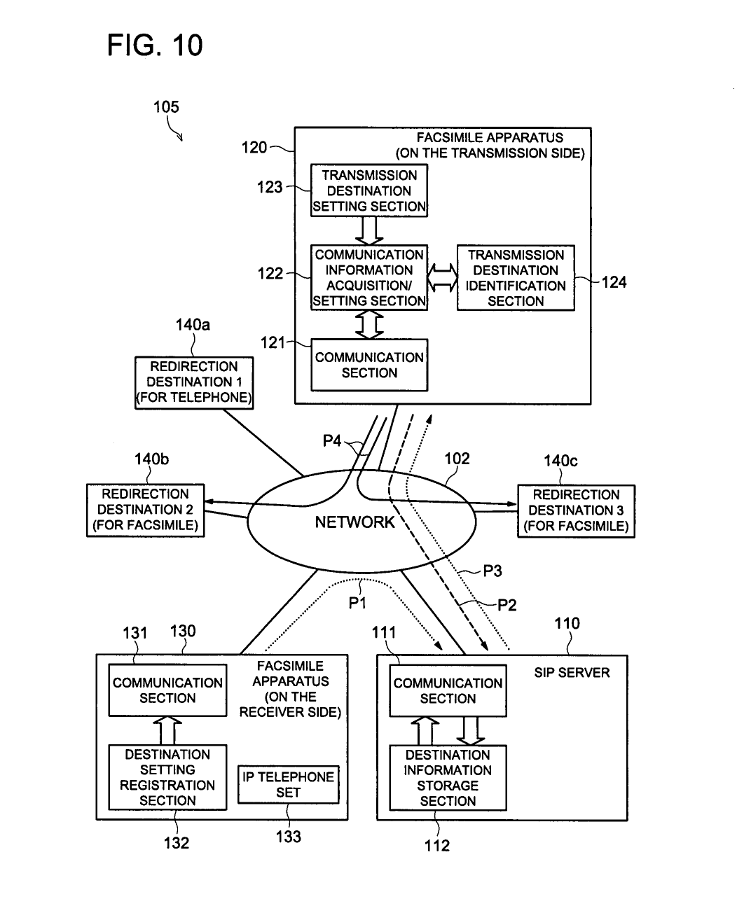

FIG. 10 shows an example of the structure of the network facsimile system 105 as an embodiment of the present invention. The network facsimile system 105 is a facsimile system wherein session control protocol is used for call connection, and peer-to-peer connection is established between the transmitter and receiver via the network 102 to send image information. It is made up of the network 102, such as the Internet, connected with the SIP server 110, facsimile apparatus 120 on the transmitter side, facsimile apparatus 130 on the receiver side and, redirection destinations 140a through 140c. The number of the apparatuses 110, 120, 130, 140a through 140c connected to the network 102 is not restricted to the one shown in the drawing. A greater number of such apparatuses can be connected.

The SIP server 110 is made up of a plurality of servers such as a proxy server, registration server, location server and redirection server. The facsimile apparatus 120 on the transmitter side is formed as a network-compatible facsimile apparatus to provide session control based on the session control protocol.

The facsimile apparatus 130 on the receiver side has the same functions of the network-compatible facsimile apparatus as those of the facsimile apparatus 120 on the transmitter side. It also includes the functions of the IP telephone set 133. The redirection destinations 140a through 140c are terminal apparatuses used as a proxy device (redirection destination) of the facsimile apparatus 130 on the receiver side. The redirection destination 140a is aa proxy device for telephone. The redirection destinations 140b through 140c are proxy devices for facsimile. The redirection destination 140a can be a network-compatible facsimile apparatus provided with the IP telephone function in addition to the IP telephone set. The redirection destinations 140b and 140c are designed as network-compatible facsimile apparatuses.

Although not illustrated, the facsimile apparatus 120 on the transmitter side, facsimile apparatus 130 on the receiver side and redirection destinations 140b and 140c for facsimile are each made up of a controller mainly formed of CPUs, a scanning section for acquiring the image data by optically scanning the document, a printing section for printing an image on a recording sheet, an operation display section for displaying the operation screen and receiving the user's operation, a hard disk apparatus for storing image data, and a communications section for communication through the network 102.

In the network facsimile system 105, the facsimile apparatus 130 on the receiver side registers in the SIP server 110 in advance the identifying information (destination information) that provides linkage between the identification information for identifying the own device and the address information (IP address of the own device in this case) on the network 102 (FIG. 10, P1). In this embodiment, the identification information for identifying the own device is assumed as a FAX telephone number (FAX number) of the public line.

When requested for connection by the facsimile apparatus 120 on the transmitter side using the FAX number of the facsimile apparatus 130 on the receiver side (P2), the SIP server 110 seeks the IP address registered in the form linked with the FAX number. This IP address is used for call connection between the facsimile apparatus 120 on the transmitter side and facsimile apparatus 130 on the receiver side. A desired method can be used to transmit image data subsequent to call connection. For example, it is possible to use a protocol conforming to the Recommendation T.38 of the ITU-T (International Telecommunication Union-Telecommunication sector).

The facsimile apparatus 130 on the receiver side can request the SIP server 110 to temporarily register the destination information (identifying information of the other device) (hereinafter referred to as “redirection setting”) including the IP address of the other device (e.g., proxy devices such as redirection destinations 140a through 140c) other than the own device in a form linked with the FAX number (the identifying information of the own device) of the own device (P1 of FIG. 10). If there is a request from facsimile apparatus 120 on the transmitter side for connection with the FAX number provided with redirection setting (P2), the SIP server 110 ensures that the destination information on the temporarily set redirection destination is reported as a redirection response to the facsimile apparatus 120 on the transmitter side which has requested for connection using that FAX number (P3). Based on the redirection destination having been reported as a redirection response, the facsimile apparatus 120 on the transmitter side executes facsimile transmission or the like (P4).

The facsimile apparatus 130 on the receiver side has the functions of a communication section 131, destination setting registration section 132 and IP telephone set 33. The communication section 131 performs the function of communicating with the SIP server 110 and other facsimile apparatuses via the network 102. The destination setting registration section 132 receives the setting operation at the redirection destination from the user, transmits the destination information (identifying information of the other device) of the set redirection destination to the SIP server 110, and registers it. In this case, a plurality of redirection destination (identifying information of the other devices) can be set with respect to one FAX number (identification information). Further, in addition to the IP address of the redirection destination (redirection address), the communication type (supplementary information for distinguishing between telephone set and facsimile apparatus) of this redirection destination is set and registered as the destination information of each redirection destination.

The SIP server 110 serves the functions of the communication section 111 and destination information storage section 112. The communication section 111 communicates with the facsimile apparatuses 120 and 130 via the network 102. For each FAX number, the destination information storage section 112 stores the information that shows if the FAX number is in the process of redirection setting or not. For the FAX number without redirection being set, the destination information storage section 112 stores the destination information (identifying information of the facsimile apparatus 130 on the receiver side) that links the FAX number with the IP address of the facsimile apparatus having that FAX number. Further, for the Fax number with the redirection being set, the destination information storage section 112 stores the destination information (identifying information of the other devices such as redirection destinations 140a through 410c) that provides linkage among the FAX number, the IP address (redirection address) of the redirection destination and communication type. This storage is done for a plurality of redirection destinations.

The SIP server 110 ensures that, if redirection is set for the FAX number wherein request for connection has been received, the destination information of all the redirection destinations registered in the form linked with this FAX number is returned as a redirection response to the facsimile apparatus of the source having requested the connection.

The facsimile apparatus 120 on the transmitter side performs the functions of the communication section 121, communication information acquisition/setting section 22, destination setting section 123 and destination identification section 124. The communication section 121 communicates with the SIP server 110 and other facsimile apparatuses 130 and 140a through 140c via the network 102. The destination setting section 123 receives the setting of the destination (destination terminal) for facsimile transmission from the user. In this case, the specification of the destination is reduced using the FAX number.

When communicating with other apparatuses 110, 130, 140b and 140c, the communication information acquisition/setting section 122 creates, manages and stores the information to be sent to other apparatuses, and manages and accumulates the information received from other apparatuses. Upon receipt of a redirection response from the SIP server 110, the destination identification section 124 works as the extracting section to extract the transfer destination, based on the communication type contained in the destination information (identifying information of the other device), out of a plurality of redirection destinations contained in this redirection response. The communication information acquisition/setting section 122 applies transmission to the redirection destination extracted by the destination identification section 124.

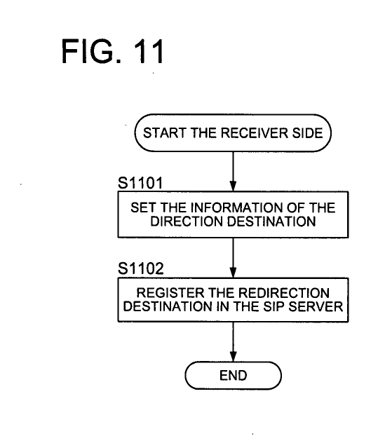

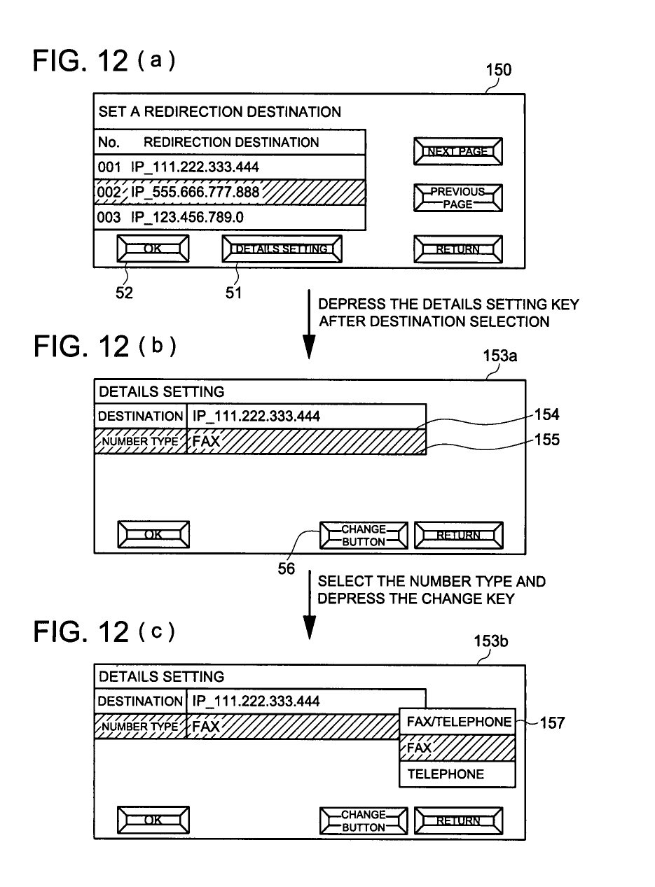

FIG. 11 shows the flow of processing when redirection setting is provided by the facsimile apparatus 130 on the receiver side. FIG. 12 shows example of the transition of the operation screen displayed on the operation display section of the facsimile apparatus 130 on the receiver side in this processing. In the first place, the destination information on redirection destination is set by the facsimile apparatus 130 on the receiver side (Step S101). To put it in greater details, at least one redirection destination is set by the user using the redirection destination setting screen 50 shown in FIG. 12(a). The user can set a plurality of redirection destinations.

If when the detail setting button 51 is operated with any one of the redirection destinations set on the redirection destination setting screen 150, the details setting screen 153a of FIG. 12(b) is displayed. The user sets the IP address of the redirection destination using the destination input column 154 of the details setting screen 53a. Further, communication type for this redirection destination is set using the number/type input column 155.

The communication type of the destination set on the destination input column 154 is inputted in the number/type input column 155. For example, the information on the type—such as a facsimile apparatus type, telephone set type, or telephone-equipped facsimile apparatus type containing both the facsimile function and telephone function—is inputted in this column. This information can be inputted by the user directly from the operation display section. The number and type can be selected from among the proxies prepared in advance. For example, if the change button 56 is depressed with the number/type input column 155 selected on the details setting screen 53a, the proxy column 157 showing the details setting screen 53b of FIG. 12(c) is displayed. The user selects the communication type from the items given in this proxy column 157.

Upon completion of the setting on the redirection destination, the OK button 52 of the redirection destination setting screen 150 is depressed. Then the destination information on the redirection destination having been set is sent to the SIP server 110 as the redirection setting, and is registered in the destination information storage section 112 of the SIP server 10 (FIG. 11, Step S1102).

In the case of the apparatus having both the telephone function and facsimile function as in the facsimile apparatus 130 on the receiver side, each of the redirection destination for telephone and the redirection destination for facsimile can be set at one or more than one position separately, in some cases.

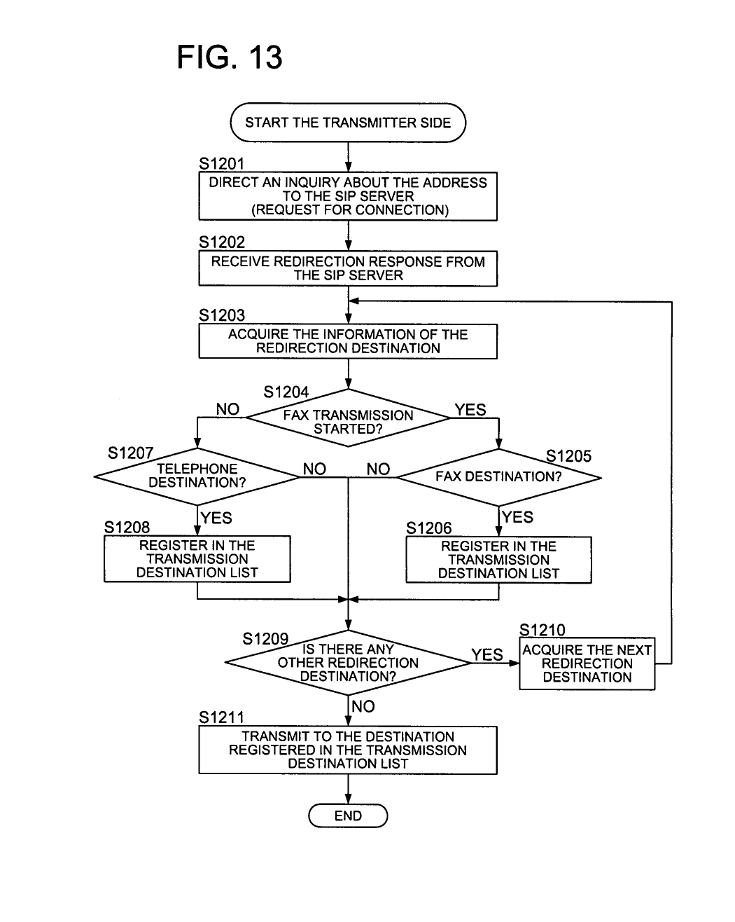

FIG. 13 shows the flow of processing in the facsimile apparatus 20 on the transmitter side. The FAX number of the destination is specified by the destination setting section 123. When the Start button of the facsimile transmission (not illustrated) is operated with the document set to a scanning section (not illustrated), the facsimile apparatus 120 on the transmitter side sends an enquiry to the SIP server 110 about the IP address corresponding to the FAX number destination (request for connection with the facsimile apparatus 130 on the receiver side corresponding to the FAX number) (Step S1201 in P2 of FIG. 10).

If redirection has been set to the FAX number of the destination, redirection response is received from the SIP server 110 as a response to the request for connection (Step S1202 in P3 of FIG. 10).

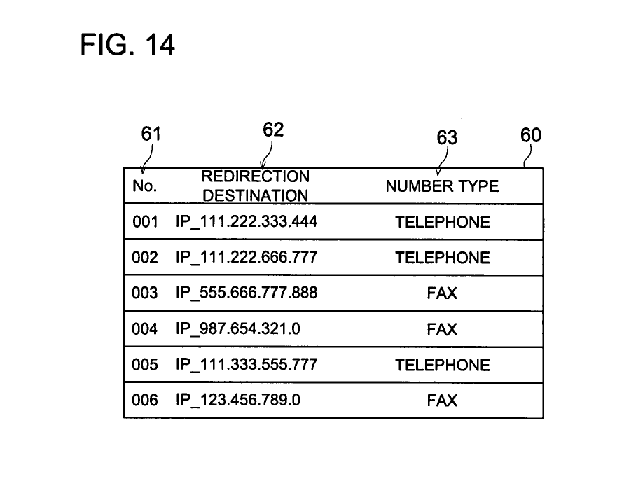

FIG. 14 is an example of the destination table 60 listing up the destination information of a plurality of redirection destinations included in the redirection response. For each redirection destination, the registration number 61, IP address (redirection destination 62 in the drawing) and communication type (number/type 63 in the drawing) are registered in the destination table 60 in the form linked with one another. In the example of FIG. 14, the communication type of the redirection destinations No. 001, No. 002 and No. 005 is “telephone”, and the communication type of the redirection destinations No. 003, No. 004 and, No. 006 is “FAX”. The redirection destination for telephone and redirection destination for facsimile are present side by side.

The facsimile apparatus 120 on the transmitter side having received the redirection response uses the destination identification section 124 to extract the redirection destination meeting the current communications purpose (facsimile transmission or telephone, etc.). To put it in greater details, the system acquires the destination information of any one of a plurality of redirection destinations received from the SIP server 110 (Step S1203). For example, the destination information of the redirection destinations sequentially from the top position of the destination table 60.

Then a decision step is taken to determine whether or not this facsimile apparatus 120 on the transmitter side has made an attempt for facsimile communication (Step S1204). If an attempt has been made for facsimile transmission (Y in Step S1204), a check is made on whether or not the communication type contained in the destination information of the redirection destination previously obtained in the Step S1203 is a facsimile type (telephone-equipped facsimile apparatus type also acceptable) (Step S1205). If the communication type is facsimile (Y in Step S1205), the redirection destination is registered in the destination list (Step S1206). If not (N in Step S1205), that redirection destination is not registered in the transmission destination list.

If this facsimile apparatus 120 on the transmitter side has not made an attempt for facsimile communication (N in Step S1204), a check is made on whether or not the communication type contained in the destination information redirection destination having been obtained in Step S1203 is a telephone type (telephone-equipped facsimile apparatus type) (Step S1207). If it is a telephone type (Y in Step S1207), that redirection destination is registered in the transmission destination list (Step S1208). If not (N in Step S1207), that redirection destination is not registered in the transmission destination list.

After registration in the transmission destination list is checked (Steps S1203 through S1208) as described above, a plurality of redirection destinations received from the SIP server 110 are check to find out if there is any redirection destination whose registration is not yet checked (Step S1209). If there is any (Step S1209: Y), the next redirection destination is acquired from the redirection destination whose registration is not yet checked (Step S1210), and the system goes back to the Step S1203. Registration is checked for this redirection destination. The information set and inputted on the operation setting screen of the facsimile apparatus 120 on the transmitter side may be used for the communication purpose such as facsimile transmission or telephoning (the communication type to be used by the facsimile apparatus 120 on the transmitter side for the communication). The information of the job mode (e.g., FAX mode) of the facsimile apparatus 120 on the transmitter side information may be used for this evaluation.

When the registration in the transmission destination list has been checked (Step S1209: N) for all the redirection destinations, communication control is provided for all the redirection destinations registered in the transmission destination list. In the case of facsimile transmission, image data is transmitted (Step S1211), and the processing terminates (END).

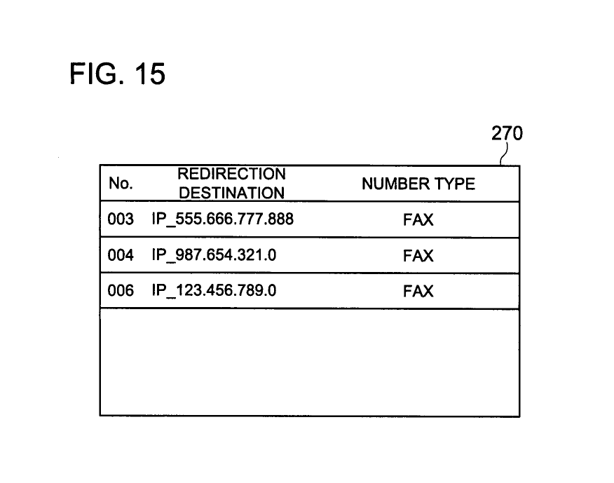

FIG. 15 shows an example of the transmission destination list 170 created from the destination table 60 of FIG. 14 when an attempt was made for facsimile transmission. Of the redirection destinations registered in the destination table 60, only the redirection destinations having a communication type (number/type) of “FAX” (facsimile) are extracted and are formulated in a list. In this example, the redirection destinations No. 003, No. 004 and No. 006 are automatically selected to start facsimile transmission.

As described above, the redirection destinations meeting the original communication purpose (facsimile transmission or telephone) are automatically extracted. Then the system automatically starts facsimile transmission to the redirection destinations having been extracted. Even when the redirection destination for telephone and the redirection destination for facsimile are separately set with respect to one facsimile apparatus 130 on the receiver side, image information is transmitted only to the redirection destination for facsimile if an attempt was made for facsimile transmission, for example, to this facsimile apparatus 130 on the receiver side. This arrangement eliminates the possibility of incorrect facsimile transmission given to the redirection destination for telephone.

In the second embodiment, the supplementary information can be any information for selecting a redirection destination. It includes the communication type and redirection site.

The identifying information of the other device is the information for identifying the other device on the network. It includes the IP address and e-mail address.

In the second embodiment, when an attempt is made for facsimile transmission to the transmission destination terminal having requested connection, the redirection destination having the same supplementary information as that of the original destination (transmission destination terminal) is extracted from a plurality of redirection destinations received as a redirection response.

In the second embodiment, the communication type indicates the type of the communication that can be received by the apparatus. For example, it shows that the apparatus is a telephone set for communication, or a facsimile apparatus.

In the second embodiment, the redirection destination is extracted according to the supplementary information such as the communication type. Thus, the image information to be transmitted to the transmission destination terminal is automatically transmitted to the extracted redirection destination.

In the second embodiment, the network facsimile apparatus on the receiver side sends to the SIP server the identifying information of the own device, and the identifying information including the supplementary information of a plurality of other devices (redirection destinations) linked with the identifying information of the own device, which are registered in this server. When the SIP server is requested by the network facsimile apparatus on the transmitter side to connect with the network facsimile apparatus on the receiver side, the SIP server ensures that the identifying information including the supplementary information of a plurality of other devices having been registered is transmitted, as a proxy device of the network facsimile apparatus on the receiver side, to the network facsimile apparatus on the transmitter side as a redirection response. In response to this, the network facsimile apparatus on the transmitter side, redirection destinations having predetermined supplementary information are extracted from a plurality of redirection destinations reported by the redirection response. The extracted redirection destination is transmitted as a proxy destination.

The identifying information of the own device for registration in the SIP server can be defined as the identification information for the SIP server to identify this network facsimile apparatus in the session control protocol. For example, the FAX number of the own device is utilized. The identifying information of the other device is the information for identifying the other device over the network so that the own device and other device communicate with each other via the network. For example, the IP address and e-mail address are used.

According to the network facsimile apparatus and network facsimile system as a second embodiment, based on the supplementary information such as a communication type, the redirection destination is automatically selected from among the proxy addresses returned as redirection responses, and is used as a proxy destination. For example, control can be provided in such a way that, when the proxy address for telephone and the proxy address for facsimile set for one FAX number have been returned by the redirection response, only the proxy address for facsimile is automatically selected, if the original transmission is facsimile transmission. This arrangement eliminates the possibility of incorrect transmission to a wrong communication type destination.

For example, when there is no redirection destination for facsimile at all in the redirection response for facsimile transmission, an error is reported to the user, and processing then terminates.

Further, the communication type is classified into three types—a telephone type, facsimile type and a telephone/facsimile type—for management. For example, if there are a plurality of transmission formats for network facsimile (conforming to the Recommendation T.37 or T.38 of the ITU-T, etc.), they can be further classified.

The aforementioned second embodiment was explained with an example wherein a desired redirection destination was extracted from a plurality of redirection destinations as supplementary information based on the communication type. Without the present invention being restricted thereto, however, it is also possible to make such arrangements that the site information on the redirection destination is registered as supplementary information, and the redirection destination is extracted according to this site information. When this format is utilized, the redirection destination meeting the conditions on the transmitter side is automatically selected first as a redirection destination, and communication control is executed.

The following describes a third embodiment of the present invention with reference to drawings:

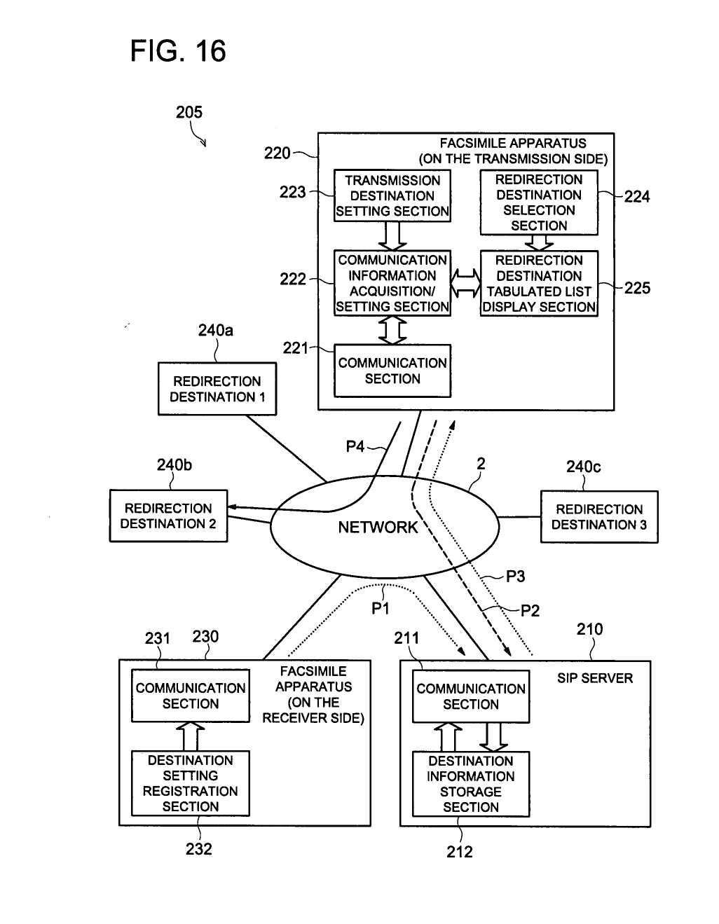

FIG. 16 shows an example of the structure of a network facsimile system 205 as an embodiment of the present invention. The network facsimile system 205 is a facsimile system wherein a session control protocol is used to establish call connection, and peer-to-peer connection is established between the transmitter and receiver via the network 2, thereby sending the image information. It is made up of the network 2 such as the Internet connected with a SIP server 210, facsimile apparatus 220 on the transmitter side, facsimile apparatus 30 on the receiver side, and redirection destinations 40a through 40c. The number of the apparatuses 210, 220, 230, 240a through 240c connected to the network 2 is not restricted to the illustrated one. A greater number of them can be connected.

The SIP server 10 is made up of a plurality of servers such as a proxy server, registration server, location server and redirection server. The facsimile apparatus 220 on the transmitter side, facsimile apparatus 230 on the receiver side and redirection destination 240a through 240c are structured as a network-compatible facsimile apparatus to perform session control based on the session control protocol. Although not illustrated, each of them is made up of a controller mainly formed of a CPU, a scanning section for scanning the document optically and acquiring the image data, a printing section for printing an image on the recording sheet, an operation display section for displaying an operation screen and receiving the user operation, a hard disk apparatus for storing image data, and a communication section for carrying out communication via the network 2.

In the network facsimile system 5, the facsimile apparatus 230 on the receiver side registers in advance the identifying information (destination information) wherein the identification information for identifying the own device and the address information over the network 2 (IP address of the own device in this case) are linked with each other with respect to the SIP server 210 (P1 of FIG. 16). In this embodiment, the identification information for identifying the own device is assumed to be a FAX telephone number (FAX number) on the public line.

Upon receipt of request for connection (P2) from the facsimile apparatus 220 on the transmitter side using the FAX number of the facsimile apparatus 230 on the receiver side, the SIP server 210 seeks the IP address registered and linked with the FAX number. Using this IP address, it establishes a call connection between the facsimile apparatus 220 on the transmitter side and facsimile apparatus 230 on the receiver side. Subsequent to call connection, image data can be sent by any transmission method. For example, a protocol conforming to the Recommendation T.38 of the ITU-T (International Telecommunication Union-Telecommunication sector) is used.

The facsimile apparatus 30 on the receiver side can request the SIP server 10 to execute temporary registration (hereinafter referred to as “redirection setting”) of the destination information (identifying information of the other device) of the IP address of the other device other than the own device (e.g., proxy devices such as redirection destinations 240a through 240c) in the form linked with the FAX number of the own device (P1 of FIG. 16). If the FAX number for which redirection has been set is required for connection by the facsimile apparatus 20 on the transmitter side (P2), the SIP server 10 ensures that the destination information of the currently temporarily set redirection destination for that FAX number is reported to the facsimile apparatus 220 on the transmitter side at the source having requested connection as a redirection response (P3). The facsimile apparatus 220 on the transmitter side executes facsimile transmission to the destination selected from among the reported redirection destinations reported by the redirection response (P4).

The facsimile apparatus 230 on the receiver side includes combines the functions of communication section 31, destination setting registration section 232 and IP telephone set 233. The communication section 231 communicates with the SIP server 210 and other facsimile apparatuses via the network 2. In response to the operation of setting the redirection destination by the user, the destination setting registration section 232 sends the destination information of the redirection destination having been set (identifying information of the other device) to the SIP server 210 wherein it is registered. In this case, a plurality of redirection destinations (identifying information of the other devices) can be set with respect to one FAX number (identification information). The communication type of this redirection destination (supplementary information indicating the distinction between the telephone set and facsimile apparatus) can be set and registered as the destination information of each redirection destination, in addition to the IP address (redirection address) of the redirection destination.

The SIP server 210 combines the functions of the communication section 211 and destination information storage section 212. The communication section 211 communicates with the facsimile apparatuses 220 and 230 and others via the network 2. For each FAX number, the destination information storage section 212 stores the information indicating whether or not the redirection has been set to the FAX number. For the FAX number for which redirection is not set, the destination information storage section 212 stores the destination information (the identifying information of the facsimile apparatus 230 on the receiver side) providing linkage between the FAX number and IP address of the facsimile apparatus of that FAX number. For the FAX number for which redirection is set, the destination information storage section 212 stores the destination information (identifying information of the other devices such as redirection destination 240a through 240c) providing linkage among the FAX number, IP address of the redirection destination (redirection address) and communication type, and this storage is done for a plurality of redirection destinations.

When redirection setting has been completed for the FAX number having received the request for connection, the SIP server 210 ensures that the destination information of all the redirection destinations registered in the form linked with this FAX number is returned to the facsimile apparatus of the source having requested for connection, as a redirection response.

The facsimile apparatus 220 on the transmitter side combines the functions of the communication section 221, communication information acquisition/setting section 222, transmission destination setting section 223, redirection destination selector 224 and redirection destination tabulated list display section 225. The communication section 221 communicates with the SIP server 210 and other facsimile apparatuses 230 and 240a through 240c via the network 2. The transmission destination setting section 223 receives the destination (transmission destination) at the time of facsimile transmission from the user. In this case, the specification of destination is received as the FAX number

At the time of communication with other apparatuses 210, 230 and 240a through 240c, the communication information acquisition/setting section 222 creates, manages and stores the information to be sent to other devices, and manages and stores the information received from other apparatuses. Upon receipt of redirection response from the SIP server 210, the redirection destination tabulated list display section 225 serves the function of displaying the destination information of a plurality of redirection destinations contained in this redirection response (identifying information of the other device). The redirection destination selector 224 serves the function of a selector that selects a desired one or a plurality of redirection destinations from among a plurality of redirection destinations wherein destination information is shown in the redirection destination tabulated list display section 225.

The contents shown on the redirection destination tabulated list display section 225 are controlled according to various attribute information items contained in the destination information. For example, from among a plurality of redirection destinations indicating the redirection response received from the SIP server 210, only those meeting the predetermined conditions are extracted or displayed. Alternatively, different display formats are used to display the destinations meeting the predetermined conditions and those failing to meet such conditions.

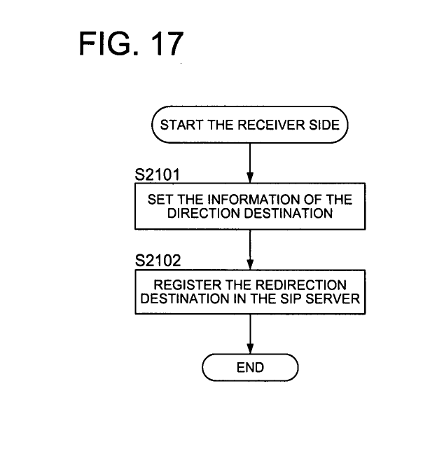

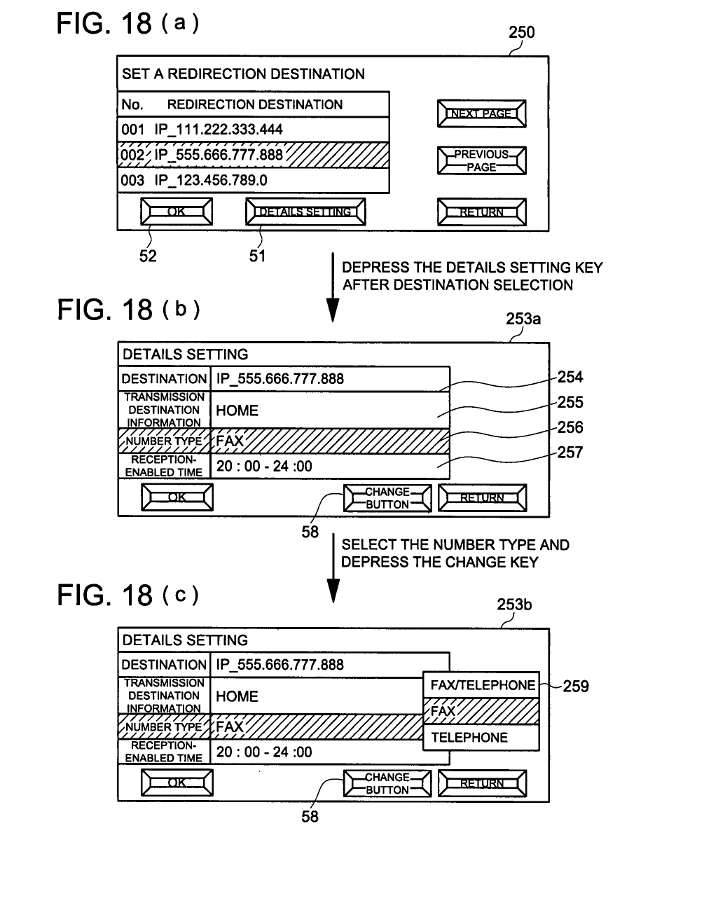

FIG. 17 shows the flow of processing when the facsimile apparatus 230 on the receiver side sets the redirection. FIG. 18 shows an example of the transition of the operation screen displayed on the operation display section of the facsimile apparatus 230 on the receiver side in this processing. In the first place, in the facsimile apparatus 230 on the receiver side, the destination information of the redirection destination is set. (Step S2101). To put it in greater details, at least one redirection destination is set by the use on the redirection destination setting screen 250 shown in FIG. 18(a). A plurality of redirection destinations can be set by the user.

When any one of the redirection destinations has been selected on the redirection destination setting screen 250, the details setting screen 53a shown in FIG. 18(b) appears if the detail setting button 51 is operated. The user sets the IP address of the redirection destination in the destination input column 254 of the details setting screen 253a. The position information (transmission destination information) can be set in the transmission destination information input column 255 as the attribute information of this redirection destination. The communication type can be set in the number/type input column 256, and the reception-enabled time can be set in the reception-enabled time input column 257. The information denoting the position on the receiver corresponding to the destination set in the destination input column 254 is inputted in the transmission destination information input column 255. For example, the address of the home and company name are inputted there.

The communication type of the receiver corresponding to the destination set on the destination input column 254 is inputted in the number/type input column 256. For example, information on facsimile apparatus, telephone set or telephone-equipped facsimile apparatus combining both the facsimile and telephone functions is inputted therein. The time zone wherein there is a greater probability of the user present close to the receiver corresponding to the destination preset on the destination input column 254 is inputted in the reception-enabled time input column 257. Such information may be inputted directly by the user from the operation display section, or a proper information item may be selected from among the proxy information items on the number and type prepared in advance. For example, when the number/type input column 256 is selected on the details setting screen 53a, the change button 58 is pressed. Then the proxy column 259 indicated on the details setting screen 53b of FIG. 18(c) is displayed, and the user selects the communication type from among the information items displayed in the proxy column 259.

Upon completion of the setting of the redirection destination, the OK button 52 of the redirection destination setting screen 250 is pressed. Then the destination information on the redirection destination having been set is sent to the SIP server 210 as a request for redirection setting, and is registered in the destination information storage section 212 of the SIP server 210 (Step S2102).

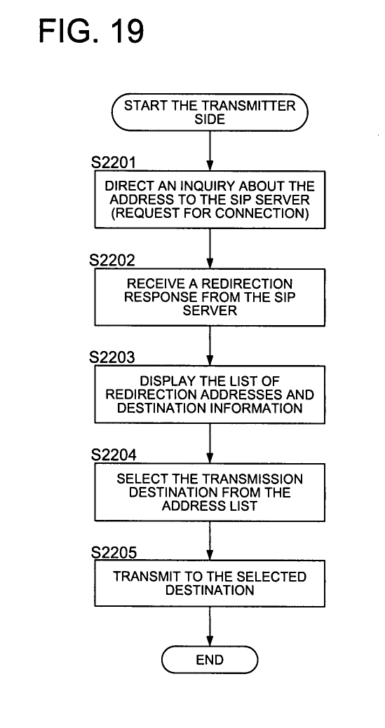

FIG. 19 shows the flow of processing in the facsimile apparatus 220 on the transmitter side. The FAX number of the transmission destination is specified by the transmission destination setting section 223 and the document is set to the scanning section (not illustrated). Under this condition, facsimile transmission Start button (not illustrated) is operated. Then the facsimile apparatus 220 on the transmitter side requests the SIP server 210 to make an enquiry about the IP address corresponding to the FAX number of the transmission destination (request for connection with the facsimile apparatus 230 on the receiver side corresponding to this FAX number) (Step S2201, P2 of FIG. 16).

In this case, if redirection is set to the FAX number of the transmission destination, a redirection response is received from the SIP server 210 (Step S2202, P3 of FIG. 16) as a response to the request for connection. The facsimile apparatus 220 on the transmitter side ensures that the destination information of all the redirection destination contained in the redirection response received from the SIP server 210 is listed on the redirection destination tabulated list display section 225 (Step S2203).

The user selects a desired destination from one or a plurality of redirection destinations displayed on the redirection destination tabulated list display section 225 by referring to the destination information of each redirection destination (Step S2204). If the redirection destination is selected, the image information which should have been transmitted to the transmission destination originally specified by the transmission destination setting section 223 is sent to the selected redirection destination (Step S2205), and processing terminates (END).

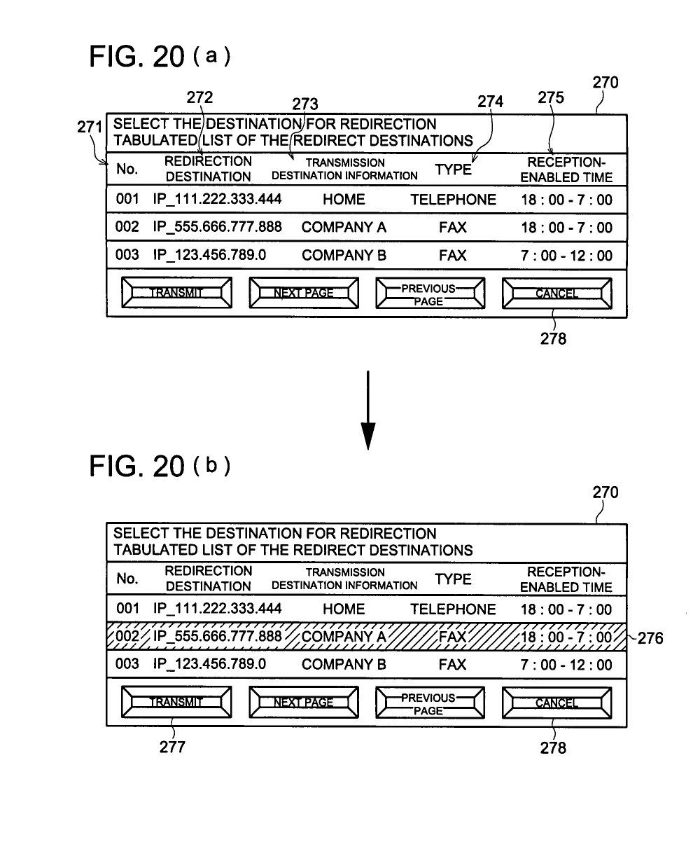

FIG. 20(a) shows an example of the tabulated list screen 270 for displaying the destination information of all the redirection destinations contained in the redirection response. On the tabulated list screen 270, the registration number 271, IP address (redirection destination 272 in the drawing), position information (transmission destination information 273 in the drawing), communication type (type 274 in the drawing), and reception-enabled time 275 are listed in a row in the form linked with one another for each redirection destination. As shown in FIG. 20(b), if the user presses the row 276 showing a desired destination information of the redirection destination, the color displayed of the row is highlighted to show the selected status. When one or a plurality of redirection destinations have been selected, the transmission button 277 is depressed. Then image information is sent to the selected redirection destination in the facsimile transmission mode.

If there is no redirection destination desired for transmission, the Cancel button 278 is depressed. This procedure allows transmission to be cancelled.

As is apparent from the foregoing description, when a plurality of redirection destinations are set for one FAX number, mere display of the IP address is not sufficient to identify the location of each redirection destination or the type of the apparatus. However, since attribute information such as transmission destination information, type and reception-enabled time is indicated, the user can elect the optimum redirection destination by referring to such information.

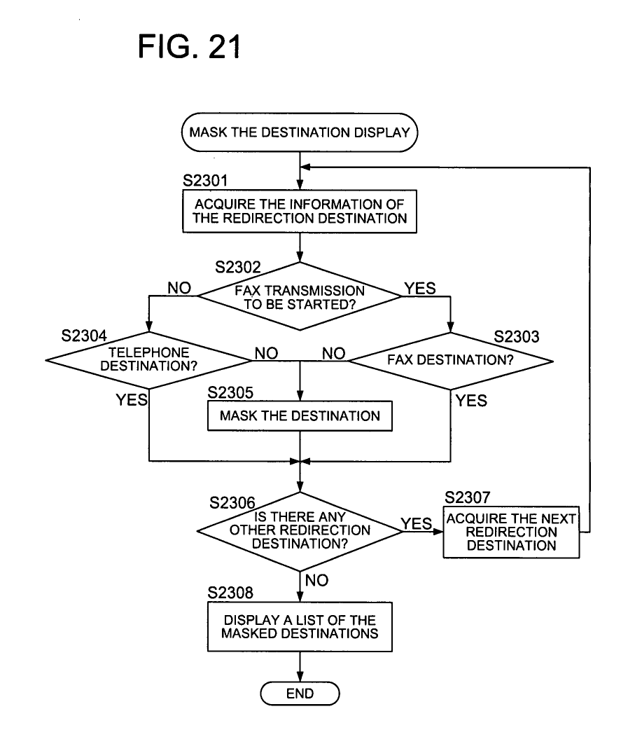

The following describes the masking of the redirection destination. FIG. 20 lists up all the destination information of the redirection destinations received from the SIP server 210. When the step of masking of FIG. 21 is provided in Step S2203 of FIG. 19, display can be given by making distinction between the redirection destinations meeting a predetermined requirement and those failing to meet it.

In the step of masking in FIG. 21, a decision step is taken to determine whether the facsimile apparatus 220 on the transmitter side was making an attempt for facsimile transmission or telephoning. Thus, the contents of display are controlled in response to the result of this decision.

To put it in greater details, any one of the destination information items of the redirection destinations is acquired from a plurality of redirection destinations received from the SIP server 210 (Step S2301). A decision step is taken to determine whether or not this facsimile apparatus 220 on the transmitter side was making an attempt for facsimile transmission (Step S2302). If it was making an attempt for facsimile transmission (Y in Step S2302), a check is made to see if the communication type included in the previously acquired destination information of the redirection destination is a facsimile type (or telephone/facsimile type) (Step S2303). If the communication type is not a facsimile type (N in Step S2303), the redirection destination is set as the target of masking (crosshatching) (Step S2305). If the communication type is a facsimile type (Y in Step S2303), the redirection destination is not set as a target of masking.

If this facsimile apparatus 220 on the transmitter side was not making an attempt for facsimile transmission (NO in Step S2302), a check is made to see if the communication type contained in the destination information of the redirection destination acquired in Step S2301 is a telephone type (or telephone/facsimile type) or not (Step S2304). If it is not a telephone type (NO in Step S2304), this redirection destination is set as a target of masking (Step S2305). If the communication type is a telephone type (YES in Step S2304), this redirection destination is not set as the target of masking.

After the aforementioned mask evaluation, a plurality of redirection destinations received from the SIP server 210 are examined to find out if there are any redirection destinations for which mask evaluation has not yet been conducted (Step S2306). If there are any (YES in Step S2306), the next redirection destination is acquired from them (Step S307). Then the system goes to Step S2301 to conduct mask evaluation on this redirection destination.

A decision on whether the facsimile apparatus 220 on the transmitter side was making an attempt for facsimile transmission or telephoning can be made by using the information set and inputted on the operation setting screen of the facsimile apparatus 220 on the transmitter side, or by using the information on the job mode (e.g., FAX mode) in the facsimile apparatus 220 on the transmitter side.

If mask evaluation has completed for all the redirection destinations (NO in Step S2306), redirection destinations are listed up according to the data after mask evaluation (Step S2308).

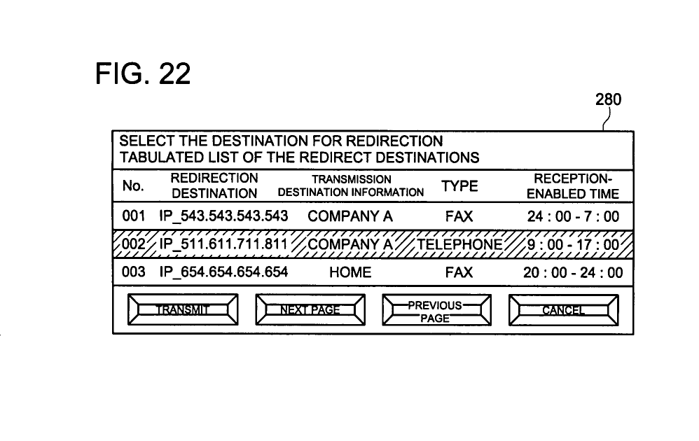

FIG. 22 shows an example of the tabulated list screen 280 listing up the destination information items of the redirection destinations according to the data subsequent to masking. In this screen 280, the redirection destination to be masked is crosshatched. Further, in this example, the facsimile apparatus 220 on the transmitter side was making an attempt for facsimile transmission. The redirection destination having the communication type of telephone is set as a target of masking and is crosshatched. The redirection destination the communication type of facsimile (or facsimile/telephone) is not the target of masking, and therefore, is not crosshatched. The user cannot select the masked redirection destination as a transmission destination. A transmission destination can be selected only from among the unmasked (not crosshatched) redirection destinations.

As is apparent from the foregoing description, this arrangement displays the redirection destination conforming to the original communication objective (facsimile transmission or telephoning) and the redirection destination not conforming to the original communication object, wherein these two types of destinations are clearly distinguished from each other. At the same time, this arrangement also ensures that the redirection destination conforming to the objective cannot be selected as the transmission destination, and protects the system against possible facsimile transmission to the redirection destination for telephone.

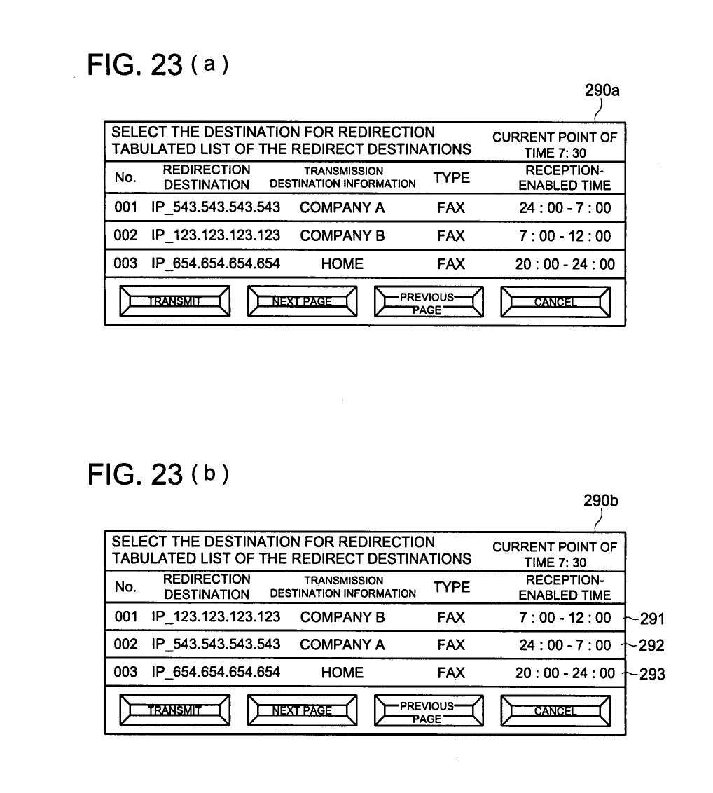

FIG. 23(a) shows an example of the tabulated list screen 290a wherein only the redirection destinations which are not the target of masking are extracted and displayed. FIG. 23(b) shows an example of the tabulated list screen 90b wherein a further process of sorting (rearrangement) is applied to the screen of FIG. 23(a), based on the reception-enabled time. In FIG. 23(a), the redirection destination having a communication type of telephone is excluded from the items to be displayed. Only the redirection destinations with a communication type of facsimile are extracted and listed up. As will be apparent from the foregoing description, only the redirection destinations conforming to the original communication objective (facsimile transmission) are displayed on the tabulated list screen 290a. This arrangement eliminates the need of the user having to select according to the presence or absence of crosshatching, as shown in FIG. 22, and further facilitates the user's work involved in making a decision in selecting a transmission destination and operating the step of selection.

In FIG. 23(b), the current point of time is compared with the reception-enabled time of each redirection destination, and a higher display priority is placed to the redirection destinations (higher position in the list) corresponding to the reception-enabled time wherein the current point of time is set. Of the redirection destinations without the current point of time specified within the reception-enabled time, those having the current point of time closer to the reception-enabled time are assigned with a higher display priority. In the example of FIG. 23(b), the current point of time is “7:30”, and therefore, the redirection destination (Company B) 291 having a reception-enabled time of “7:00 through 12:00” is displayed at No. 001 which is the top position in the list. Further, the redirection destination (Company A) 92 having the reception-enabled time of “24:00 through 7:00” has a difference of 30 minutes from the current point of time. The redirection destination (home) 293 with a reception-enabled time of “20:00 through 24:00” has a difference of 7 hours and 30 minutes from the current point of time, and therefore, the former 292 with smaller time difference is displayed at a higher position than the latter 293.

As described above, the redirection destination characterized by higher probability of presence of a person nearby is displayed at a higher position. This allows the user to select a proper redirection destination easily.

It is also possible to make such arrangements that the redirection destination with the current point of time kept within the reception-enabled time is automatically transmitted, independently of whether the user has selected or not.

The embodiments of the present invention have been described with reference to diagrams. It is to be expressly understood, however, that the specific structures are not restricted to those shown in the embodiment. The present invention can be embodied in a great number of variations with appropriate modification or additions, without departing from the technological spirit and scope of the invention claimed.

For example, in facsimile transmission, it is also possible to arrange such a configuration that, when the user has operated the transmission button without selecting any redirection destination, the following operations [1] through [3]are performed:

[1] Transmission is made to all the redirection destinations having been received by redirection response if they belong to the communication type of facsimile.

[2] Comparison is made between the current point of time and the reception-enabled time of the redirection destination for each of the redirection destinations that have been received by redirection response and belong to the communication type of facsimile. If there is a redirection destination with the current time kept within the reception-enabled time, automatic transmission is made to that redirection destination. If there is no redirection destination with the current time kept within the reception-enabled time, transmission is made to the redirection destination having the communication type of facsimile and the earliest registration number.

[3] Transmission is made to the redirection destination which has been received by redirection response and has the earliest registration number and the communication type of facsimile.

In this case, the registration number can be equivalent to the order subsequent to sorting according to reception-enabled time and others, or the order of being registered in the SIP server 210 as redirection destinations. This number can be determined by an appropriate standard. If the attribute information of the redirection destination is properly utilized, the redirection destination can be selected automatically in the facsimile apparatus 220 on the transmitter side without waiting for the user's selection.

Further, in the aforementioned embodiment, the attribute information of the redirection destination is exemplified by position information, communication type and reception-enabled time. Other the attribute items can be used if they can be used as an index for selecting the redirection destination. For example, the properties of the redirection destination (e.g., the maximum sheet size) can be used. Further, the position information is exemplified by a home and company in the above description. The floor of the building, department or branch name of the company can be used for this purpose. In the communication type, when there are more than one transmission format (conforming to T.37 and T.38 of ITU-T) for network facsimile, they can be distinguished.

In the aforementioned embodiment, sorting is performed according to the reception-enabled time. It is also possible to arrange such a configuration that a plurality of items serving as a standard for sorting procedure can be set. For example, sorting is made based on the reception-enabled time. If there are a plurality of redirection destinations having the current point of time kept within the reception-enabled time, they are further sorted according to the second standard (e.g., transmission destination information of company assigned with higher priority than that of home), and are displayed.

The embodiments of the present invention have been described with reference to diagrams. It is to be expressly understood, however, that the specific structures are not restricted to those shown in the embodiments. The present invention can be embodied in a great number of variations with appropriate modification or additions, without departing from the technological spirit and scope of the invention claimed.

For example, the one other device (the specified redirection destination) automatically registered in the SIP server 30 is selected from among a plurality of other devices stored in the network information storage section 17. However, it is also possible to arrange such a configuration that only one other device is stored in the network information storage section 17, and this other device is automatically registered in the SIP server 30.

The above description of the first embodiment contains an example wherein redirection setting into the SIP server 30 and cancellation of the redirection setting are conducted automatically in response to occurrence of a predetermined event. The following arrangement can also be used: Redirection setting based on the information stored in the network information storage section 17, and cancellation of that setting are manually operated sequentially by the user. In this case as well, the identifying information of the other device is already stored in the network information storage section 17. This reduces the user's workload as compared to the case of having to input the identifying information of the other device every time.

What is claimed is:

1. A network facsimile apparatus for providing session control based on a session control protocol, comprising:
a storage section for storing identifying information for identifying the own network facsimile apparatus, and identifying information for identifying a network facsimile apparatus other than the own apparatus; and
a registration section for registering proxy destination information in a SIP server arranged on a network, the proxy destination information links the identifying information of the apparatus other than the own apparatus with the identifying information of the own apparatus each stored in the storage section.

2. The network facsimile apparatus of claim 1, wherein the storage section stores identifying information for identifying each of a plurality of network facsimile apparatuses other than the own apparatus, the own apparatus further comprising:
a selector for selecting one of the plurality of network facsimile apparatuses, wherein the identifying information for identifying each of the plurality of facsimile apparatuses is stored in the storage section.

3. The network facsimile apparatus of claim 1, further comprising:
a search range setting section for setting a search rage; and
a search section for searching a network facsimile apparatus other than the own apparatus in the search range set by the search range setting section;
wherein the registration section stores the identifying information identifying the network facsimile apparatus extracted by the searching by the search section.

4. The network facsimile apparatus of claim 1, wherein the registration section registers the proxy destination information in the SIP sever when a power source of the own apparatus is turned off.

5. The network facsimile apparatus of claim 4, further comprising registration canceling section to cancel the proxy destination information set in the SIP sever when a power source of the own apparatus is turned on.

6. The network facsimile apparatus of claim 1, wherein the registration section registers the proxy destination information in the SIP server when an operation mode of the own apparatus has shifted to one of administrator mode and service mode.

7. The network facsimile apparatus of claim 6, further comprising;
registration canceling section to cancel the proxy destination information set in the SIP sever when the operation mode of the own apparatus has shifted out from one of the administrator mode and the service mode.

8. The network facsimile apparatus of claim 1, further comprising;
registration time specifying section for specifying a time at which to register the proxy destination information in the SIP server, wherein the registration section registers the proxy destination information in the SIP server upon arrival of the time specified by the registration specifying section.

9. The network facsimile apparatus of claim 1, further comprising; canceling time specifying section for specifying a time at which to cancel the proxy destination information in the SIP server, wherein the registration section cancels the proxy destination information registered in the SIP server.

10. The network facsimile apparatus of claim 1, wherein the registration section registers proxy destination information in the SIP server, the proxy destination information is linked with the identifying information of the other network facsimile apparatus which is conforming to the type of the event having occurred.

11. A network facsimile apparatus for providing session control based on a session control protocol, comprising:
a requesting section for requesting a SIP server arranged on a network to connect with a destination terminal;
a receiving section for receiving, from the SIP server, identifying information including supplementary information of a plurality of devices other than the destination terminal, as a response to the request for connection; and
an extracting section for extracting the identifying information including predetermined supplementary information, out of the identifying information of the plurality of devices received by the receiving section,
wherein the network facsimile apparatus provides communication control in which the destination indicated by the identifying information extracted by the extracting section is used as a proxy destination of the destination terminal.

12. The network facsimile apparatus of claim 11, the extracting section extracts identifying information having the same supplementary information as the supplementary information that is used for the transmission to the destination terminal.

13. The network facsimile apparatus of claim 11, further comprising; a setting section for setting the predetermined supplementary information relating to extraction of identifying information, wherein the extracting section extracts the identifying information based on the supplementary information set by the setting section

14. The network facsimile apparatus of claim 11, wherein the supplementary information is information representing a communication type.

15. The network facsimile apparatus of claim 11, wherein the network facsimile apparatus transmits image information to be transmitted to the destination terminal to a destination represented by the identifying information extracted by the extracting section.

16. A network facsimile system comprising:
a network facsimile apparatus on a transmitter side for providing session control based on a session control protocol;
a network facsimile apparatus on a receiver side; and
a SIP server arranged on a network;
wherein the network facsimile apparatus on the receiver side sends identifying information of the own apparatus, and identifying information including the supplementary information of a plurality of other apparatuses linked with the identifying information of the own apparatus, and registers such information in the SIP server;
wherein the network facsimile apparatus on the transmitter side requests the SIP server to connect with the network facsimile apparatus on the receiver side;
the SIP server, when required by the network facsimile apparatus on the transmitter side to connect with the network facsimile apparatus on the receiver side, ensures that the identifying information including the supplementary information of a plurality of other apparatuses registered in the form linked with the identifying information of the network facsimile apparatus on the receiver side is transmitted to the network facsimile apparatus on the transmitter side; and
the network facsimile apparatus on the transmitter side, when the identifying information including the supplementary information of the plurality of other apparatuses other than the network facsimile apparatus on the receiver side has been received from the SIP server, as a response to the request for connection, extracts the identifying information including predetermined supplementary information, out of the identifying information of the plurality of other apparatuses having been received, and provides communication control wherein the destination indicated by the extracted identifying information is used as a proxy destination of the destination terminal.

17. A network facsimile apparatus for providing session control based on a session control protocol, comprising:
a registration section for registering in a SIP server arranged on a network, identifying information for identifying the own apparatus and identifying information for identifying a plurality of other network facsimile apparatuses capable of being used as a proxy for the own apparatus, wherein the identifying information for identifying the own apparatus is linked with the identifying information for identifying the other network facsimile apparatuses.

18. The network facsimile apparatus of claim 17, wherein the identifying information for identifying the plurality of other network facsimile apparatuses to be registered in the SIP server includes attribute information of the plurality of other network facsimile apparatuses.

19. The network facsimile apparatus of claim 18, wherein attribute information includes at least one of position information, communication type and information on a reception-enabled time of the plurality of other network facsimile apparatuses.

20. A network facsimile apparatus for providing session control based on a session control protocol, comprising:
a requesting section for requesting a SIP server arranged on a network to connect with a destination terminal;
a receiving section for receiving, from the SIP server, identifying information of a plurality of other network facsimile apparatuses other than the destination terminal, as a response to the request for connection; and
a display section for displaying the identifying information for identifying the network facsimile apparatus of the plurality of other network facsimile apparatuses received by the receiving section.

21. The network facsimile apparatus of claim 20, wherein the identifying information for identifying the plurality of other network facsimile apparatuses to be displayed on the displaying section includes attribute information of the plurality of other network facsimile apparatuses.

22. The network facsimile apparatus of claim 21, wherein the attribute information includes position information of the plurality of other network facsimile apparatuses.

23. The network facsimile apparatus of claim 21, wherein the attribute information includes information on a reception-enabled time of the plurality of other network facsimile apparatuses.

24. The network facsimile apparatus of claim 20, wherein the identifying information of other network facsimile apparatus displayed on the display section is controlled based on the information of other network facsimile apparatus received from the SIP server.

25. The network facsimile apparatus of claim 23, wherein the identifying information of other network facsimile apparatus displayed on the display section is controlled based on the information on the reception-enabled time of the plurality of other network facsimile apparatuses.

26. The network facsimile apparatus of claim 24, wherein the network facsimile apparatus displays, in the display control, information of other network facsimile apparatus whose identifying information meets a predetermined condition among the identifying information of other network facsimile apparatuses received from the SIP server.

27. The network facsimile apparatus of claim 20, further comprising a selector for selecting one or more of the identifying information of the plurality of network facsimile apparatuses displayed on the display section.

28. A network facsimile system comprising:
a network facsimile apparatus on a transmission side for providing session control based on a session control protocol;
a network facsimile apparatus on a receiver side; and
a SIP server arranged on a network;
wherein the network facsimile apparatus on the receiver side sends identifying information for identifying the own apparatus and identifying information for identifying a network facsimile apparatus of a plurality of other apparatuses capable of being used as a proxy for the own apparatus, to the SIP server, wherein the information for identifying the own apparatus is linked with the information for identifying the network facsimile apparatus of the plurality of other apparatuses;
wherein the network facsimile apparatus on the transmitter side requires the SIP server to connect with the network facsimile apparatus on the receiver side; and
wherein the SIP server, when requested by the network facsimile apparatus on the transmitter side to connect with the network facsimile apparatus on the receiver side, sends to the network facsimile apparatus on the transmitter side the identifying information of the network facsimile apparatus of the plurality of other apparatuses registered in the form linked with the identifying information of the network facsimile apparatus on the receiver side.

29. The network facsimile system of claim 28, wherein the network facsimile apparatus on a transmission side, when received identifying information identifying a plurality of network facsimile apparatuses other than network facsimile apparatus on the receiver side from the SIP server as a response to a connection request from the network facsimile apparatus on the transmission side, displays the received identifying information identifying the plurality of network facsimile apparatuses.
